(19) United States
(12) Patent Application Publication
(10) Pub. No.: US 2026/0111705 A1
(43) Pub. Date: Apr. 23, 2026

(54) MANY-IN-ONE ELASTIC NEURAL NETWORKS

(71) Applicant: NVIDIA Corporation, Santa Clara, CA (US)

(72) Inventors: Ruisi Cai, Austin, TX (US); Saurav Muralidharan, San Jose, CA (US); Hongxu Yin, San Jose, CA (US); Jan Kautz, Lexington, MA (US); Pavlo Molchanov, Mountain View, CA (US)

(21) Appl. No.: 19/074,648

(22) Filed: Mar. 10, 2025

Related U.S. Application Data
(60) Provisional application No. 63/709,572, filed on Oct. 21, 2024.

(51) Int. Cl. G06N 3/045; G06N 3/0475; G06N 3/0985

(52) U.S. Cl. CPC G06N 3/045; G06N 3/0475; G06N 3/0985

(57) ABSTRACT

Apparatuses, systems, and techniques to select, from an elastic neural network, a sub-network that satisfies deployment constraints. In at least one embodiment, a sub-network is selected from an elastic neural network by using routers trained to select candidate sets of network architecture elements for each of a plurality of network architecture axes, including attention heads, MLP width, embedding dimension, and number of layers. In at least one embodiment, the elastic neural network is a large language model (LLM), and each transformer block of the LLM has a uniform architecture, thereby facilitating hardware acceleration during training and/or inference.

### CLAIM OF PRIORITY

This application claims the benefit of U.S. Provisional Application No. 63/709,572, titled “Many-in-One Large Language Models via Generalized Pruning and Weight Sharing” and filed Oct. 21, 2024, the entire contents of which is incorporated herein by reference.

### FIELD

In at least one embodiment, the present disclosure relates to processing circuitry for neural network compression and acceleration. In at least one embodiment, processing circuitry performs training and/or inferencing using elastic neural networks that include a number of unique subnetworks.

### BACKGROUND

Large language models (LLMs) have revolutionized real-world natural language processing applications, demonstrating impressive proficiency in understanding difficult contexts. Nonetheless, the substantial size of these models, typically running into several billion parameters, imposes significant constraints on their utilization in scenarios characterized by limited memory and computational resources. To address this limitation, model providers typically train multiple model variants for users to choose from (depending on system memory and computational constraints) before trying to find one or more models that satisfy the trade-off between efficiency and accuracy. For example, the Llama-2 family of models includes three different variants with 7 billion, 13 billion, and 70 billion parameters, while the Llama-3.1 family includes three different variants with 8 billion, 70 billion, and 405 billion parameters.

Training each of the multiple, multi-billion parameter variants in a family of models is extremely time, data, and resource intensive and requires substantial financial outlays. Each variant in a model family is typically trained from scratch using a training dataset. For example, each variant of the Llama-3.1 model family was trained from scratch using a dataset consisting of approximately 15 trillion tokens; training the 8 billion parameter model required approximately 1.5 million GPU hours, training the 70 billion parameter model required approximately 7 million GPU hours, and training the 405 billion parameter model required approximately 31 million GPU hours. The nearly 40 million GPU hours required for training the entire Llama-3.1 model family consumed an estimated 28 million kWh of energy. The investment in GPU hardware used for training the Llama-3.1 family, combined with additional operational expenses, has been estimated to be approximately $1 billion.

As an alternative to training a model that satisfies a particular set of deployment constraints (resulting, e.g., from limited memory and computation resources) from scratch, customizable models have been developed with multiple sub-networks that allow for extraction, from a single trained model, of sub-models capable of satisfying memory and computational resource constraints. Such models typically use a supernet with elastic, nested components. Mixture-of-experts (MoE) models, which include multiple specialized models known as experts, provide for reduced computational costs via sparse activation, whereby only a subset of experts is activated for a particular input.

### BRIEF DESCRIPTION OF THE DRAWINGS

The present systems and methods for neural network compression and acceleration are described in detail below with reference to the attached drawing figures, wherein:

FIG. 1A is a flowchart of a method for continued training to transform a pretrained neural network into an elastic neural network and for zero-shot generation of a compact neural network from the elastic neural network, in accordance with an embodiment;

FIG. 1B illustrates a flowchart of a method for elastic continued training for transforming a pretrained neural network into an elastic neural network, in accordance with an embodiment;

FIG. 1C is a flowchart of a method for jointly learning neural network and router parameters, in accordance with an embodiment;

FIG. 2 is a block diagram of an example system for continued training to transform a pretrained neural network into an elastic neural network and for zero-shot generation of a compact neural network from the elastic neural network, in accordance with an embodiment;

FIG. 3A is a schematic diagram of a transformer block of a neural network, in accordance with an embodiment;

FIG. 3B is a schematic diagram illustrating the selection of a subnetwork from an elastic LLM to generate a compact LLM, in accordance with an embodiment;

FIG. 3C illustrates an example of implementing policy aware modulation within an MLP sub-block of a transformer block, in accordance with an embodiment;

FIG. 4 is a conceptual diagram of a processing system implemented using a PPU, suitable for use in implementing some embodiments of the present disclosure.

FIG. 5A illustrates an exemplary system in which the various architecture and/or functionality of the various previous embodiments may be implemented.

FIG. 5B illustrates components of an exemplary system that can be used to train and utilize machine learning, in at least one embodiment.

FIG. 6 illustrates an exemplary streaming system suitable for use in implementing some embodiments of the present disclosure.

### DETAILED DESCRIPTION

The present disclosure provides neural network architectures and machine learning techniques that support elastic, many-in-one neural networks (e.g., large language models (LLMs)) and zero-shot generation of compact neural networks that satisfy target parameter budgets. The elastic, many-in-one neural networks provide a plurality of subnetworks, each subnetwork corresponding to a selected candidate set of network architecture elements for each of a plurality of network architecture axes. Routers are trained to select subnetworks that achieve the best performance for a given target parameter budget.

In the following description, various embodiments will be described. For purposes of explanation, specific configurations and details are set forth in order to provide a thorough understanding of the embodiments. However, it will also be apparent to one skilled in the art that the embodiments may be practiced without the specific details. Furthermore, well-known features may be omitted or simplified in order not to obscure the embodiment being described.

The systems and methods described herein may be used by, without limitation, non-autonomous vehicles, semi-autonomous vehicles (e.g., in one or more advanced driver assistance systems (ADAS)), piloted and un-piloted robots or robotic platforms, warehouse vehicles, off-road vehicles, vehicles coupled to one or more trailers, flying vessels, boats, shuttles, emergency response vehicles, motorcycles, electric or motorized bicycles, aircraft, construction vehicles, trains, underwater craft, remotely operated vehicles such as drones, and/or other vehicle types. Further, the systems and methods described herein may be used for a variety of purposes, by way of example and without limitation, for machine control, machine locomotion, machine driving, synthetic data generation, model training or updating, perception, augmented reality, virtual reality, mixed reality, robotics, security and surveillance, simulation and digital twinning, autonomous or semi-autonomous machine applications, deep learning, environment simulation, object or actor simulation and/or digital twinning, data center processing, conversational AI, generative AI, light transport simulation (e.g., ray-tracing, path tracing, etc.), collaborative content creation for 3D assets, cloud computing and/or any other suitable applications.

Disclosed embodiments may be comprised in a variety of different systems such as automotive systems (e.g., a control system for an autonomous or semi-autonomous machine, a perception system for an autonomous or semi-autonomous machine), systems implemented using a robot, aerial systems, medical systems, boating systems, smart area monitoring systems, systems for performing deep learning operations, systems for performing simulation operations, systems for performing digital twin operations, systems implemented using an edge device, systems incorporating one or more virtual machines (VMs), systems for performing synthetic data generation operations, systems implemented at least partially in a data center, systems for performing conversational AI operations, systems for performing generative AI operations, systems implemented using large language models (LLMs), systems implemented using vision language models (VLMs), systems for performing light transport simulation, systems for performing collaborative content creation for 3D assets, systems implemented at least partially using cloud computing resources, and/or other types of systems.

In some examples, the machine learning model(s) (e.g., deep neural networks, language models, LLMs, VLMs, multi-modal language models, perception models, tracking models, fusion models, transformer models, diffusion models, encoder-only models, decoder-only models, encoder-decoder models, neural rendering field (NERF) models, etc.) described herein may be packaged as a microservice—such an inference microservice (e.g., NVIDIA NIMs)—which may include a container (e.g., an operating system (OS)-level virtualization package) that may include an application programming interface (API) layer, a server layer, a runtime layer, and/or at least one model “engine.” For example, the inference microservice may include the container itself and the model(s) (e.g., weights and biases). In some instances, such as where the machine learning model(s) is small enough (e.g., has a small enough number of parameters), the model(s) may be included within the container itself. In other examples—such as where the model(s) is large—the model(s) may be hosted/stored in the cloud (e.g., in a data center) and/or may be hosted on-premises and/or at the edge (e.g., on a local server or computing device, but outside of the container). In such embodiments, the model(s) may be accessible via one or more APIs—such as REST APIs. As such, and in some embodiments, the machine learning model(s) described herein may be deployed as an inference microservice to accelerate deployment of a model(s) on any cloud, data center, or edge computing system, while ensuring the data is secure. For example, the inference microservice may include one or more APIs, a pre-configured container for simplified deployment, an optimized inference engine (e.g., built using a standardized AI model deployment an execution software, such as NVIDIA's Triton Inference Server, and/or one or more APIs for high performance deep learning inference, which may include an inference runtime and model optimizations that deliver low latency and high throughput for production applications—such as NVIDIA's TensorRT), and/or enterprise management data for telemetry (e.g., including identity, metrics, health checks, and/or monitoring).

The machine learning model(s) described herein may be included as part of the microservice along with an accelerated infrastructure with the ability to deploy with a single command and/or orchestrate and auto-scale with a container orchestration system on accelerated infrastructure (e.g., on a single device up to data center scale). As such, the inference microservice may include the machine learning model(s) (e.g., that has been optimized for high performance inference), an inference runtime software to execute the machine learning model(s) and provide outputs/responses to inputs (e.g., user queries, prompts, etc.), and enterprise management software to provide health checks, identity, and/or other monitoring. In some embodiments, the inference microservice may include software to perform in-place replacement and/or updating to the machine learning model(s). When replacing or updating, the software that performs the replacement/updating may maintain user configurations of the inference runtime software and enterprise management software.

The present disclosure provides neural network architectures and machine learning techniques for providing an elastic neural network (e.g., an elastic LLM) that can yield a large number of accurate compressed models (e.g., compact LLMs) through zero-shot selection of a subnetwork that corresponds to a selection of a candidate set of network architecture elements for each of a plurality of network architecture axes. The neural network architectures and machine learning techniques provide for selection of candidate sets of attention heads (for a multi-head attention (MHA) axis), neurons (for an MLP width axis), embedding dimensions (for an embedding axis), and layers, e.g., transformer blocks, (for a model depth axis). In at least one embodiment, the neural network architectures and machine learning techniques provide an elastic LLM that can yield a large number of accurate compressed LLMs in which all layers (i.e. transformer blocks) of the compressed LLMs have a uniform architecture, thereby facilitating hardware acceleration during training and/or inference.

A method is provided for transforming a pretrained large language model (LLM) into an elastic LLM. The method includes obtaining the pretrained LLM, ranking network architecture components of the pretrained LLM for a plurality of network architecture axes, and training a router to select, based on a target compression objective, a subnetwork comprising a candidate set of network architecture components for one or more of the plurality of network architecture axes. The subnetwork includes a plurality of transformer blocks having a uniform architecture.

According to an embodiment of the method, the network architecture axes include a multi-head attention (MHA) axis, a multi-layer perceptron (MLP) axis, an embedding axis, and an LLM depth axis. The network architecture components of the MHA axis are attention heads of MHA sub-blocks, the network architecture components of the MLP axis are hidden layer neurons of MLP sub-blocks, the network architecture components of the embedding axis are embedding dimensions of an embedding space, and the network architecture components of the LLM depth axis are transformer blocks. In at least one embodiment, uniform architecture includes a uniform number of attention heads of MHA sub-blocks, a uniform number of hidden layer neurons of MLP sub-blocks, and a uniform number of embedding dimensions of an embedding space. In at least one embodiment, the uniform number of attention heads of MHA sub-blocks is selected from a pre-defined group of nested sets of attention heads, the uniform number of hidden layer neurons of MLP sub-blocks is selected from a pre-defined group of nested sets of hidden layer neurons, and the uniform number of embedding dimensions of the embedding space is selected from a pre-defined group of nested sets of embedding dimensions.

According to an embodiment of the method, the pretrained LLM includes N transformer blocks comprising an MHA sub-block with N_{A} attention heads, an MLP sub-block with a hidden layer with D neurons, and an embedding space with H embedding dimensions, wherein

$${N}_{A}^{j}$$

is the uniform number of attention heads of MHA sub-blocks, D^{j} is the uniform number of hidden layer neurons of MLP sub-blocks, and H^{j} is the uniform number of embedding dimensions of the embedding space. The subnetwork consists of N^{j} transformer blocks, and wherein

$${N}_{A}^{j} < {N}_{A} , {D}^{j} < D , {H}^{j} < H , and {N}^{j} < N .$$

In at least one embodiment, the MHA sub-blocks of the transformer blocks of the subnetwork include the

$${N}_{A}^{j}$$

highest ranked attention heads, wherein the MLP sub-blocks of the transformer blocks of the subnetwork include the D^{j} highest ranked hidden layer neurons, and wherein the embedding space of the transformer blocks of the subnetwork include the H^{j} highest ranked embedding dimensions.

According to an embodiment, the method further includes fine-tuning parameters of the pretrained LLM, and the training the router and the fine-tuning the parameters of the pretrained LLM are performed via an end-to-end training process.

According to an embodiment of the method, training the router to select, based on the target compression objective, the subnetwork includes parameterizing the subnetwork as a set of network architecture parameters for each of the plurality of network architecture axes, and modeling at least one network architecture parameter of the set of network architecture parameters as: a continuous approximation of a categorical distribution using Gumbel Softmax, or a Bernoulli variable. In at least one embodiment, the set of network architecture parameters includes the parameters

$${D}^{j} , {N}_{A}^{j} , {H}^{j} , and {λ}_{i}^{j} ,$$

wherein where D^{j} is a number of hidden layer neurons of MLP sub-blocks,

$${N}_{A}^{j}$$

is a number of attention heads of MHA sub-blocks, H^{j} is a number of embedding dimensions of an embedding space, and

$${λ}_{i}^{j}$$

is a set of binary scalers, for i=1, . . . , N, where N is a number of transformer blocks in the pretrained LLM, and wherein D^{j},

$${N}_{A}^{j} ,$$

and H^{j} are modeled as continuous distributions using Gumbel Softmax and each

$${λ}_{i}^{j}$$

is modeled as a Bernoulli variable.

According to an embodiment of the method, training the router to select, based on the target compression objective, the subnetwork is performed for a set of specified target parameter budgets.

According to an embodiment of the method, the plurality of transformer blocks of the subnetwork include at least one modulation head configured to generate, based on the selected subnetwork, a scale vector and/or a shift vector.

A non-transitory computer-readable media is provided having stored thereon executable instructions that, when executed by processing circuitry, cause the processing circuitry to perform the method for transforming a pretrained large language model (LLM) into an elastic LLM, including any embodiment thereof.

A system is provided that includes processing circuitry configured to transform a pretrained large language model (LLM) into an elastic LLM by obtaining the pretrained LLM, ranking network architecture components of the pretrained LLM for a plurality of network architecture axes, and training a router to select, based on a target compression objective, a subnetwork comprising a candidate set of network architecture components for one or more of the plurality of network architecture axes. The subnetwork includes a plurality of transformer blocks having a uniform architecture. The system further includes one or more memories configured to store the elastic LLM.

According to an embodiment of the system, the network architecture axes include a multi-head attention (MHA) axis, a multi-layer perceptron (MLP) axis, an embedding axis, and an LLM depth axis. The network architecture components of the MHA axis are attention heads of MHA sub-blocks, the network architecture components of the MLP axis are hidden layer neurons of MLP sub-blocks, the network architecture components of the embedding axis are embedding dimensions of an embedding space, and the network architecture components of the LLM depth axis are transformer blocks. According to at least one embodiment, the uniform architecture includes a uniform number of attention heads of MHA sub-blocks, a uniform number of hidden layer neurons of MLP sub-blocks, and a uniform number of embedding dimensions of an embedding space. According to at least one embodiment, the uniform number of attention heads of MHA sub-blocks is selected from a pre-defined group of nested sets of attention heads, the uniform number of hidden layer neurons of MLP sub-blocks is selected from a pre-defined group of nested sets of hidden layer neurons, and the uniform number of embedding dimensions of the embedding space is selected from a pre-defined group of nested sets of embedding dimensions.

According to an embodiment of the system, the pretrained LLM includes N transformer blocks comprising an MHA sub-block with N_{A} attention heads, an MLP sub-block with a hidden layer with D neurons, and an embedding space with H embedding dimensions.

$${N}_{A}^{j}$$

is the uniform number of attention heads of MHA sub-blocks, D^{j} is the uniform number of hidden layer neurons of MLP sub-blocks, and H^{j} is the uniform number of embedding dimensions of the embedding space. The subnetwork consists of N^{j} transformer blocks, and

$${N}_{A}^{j} < {N}_{A} , {D}^{j} < D , {H}^{j} < H , and {N}^{j} < N .$$

In at least one embodiment, the MHA sub-blocks of the transformer blocks of the subnetwork include the

$${N}_{A}^{j}$$

highest ranked attention heads, the MLP sub-blocks of the transformer blocks of the subnetwork include the D^{j} highest ranked hidden layer neurons, and the embedding space of the transformer blocks of the subnetwork include the H^{j} highest ranked embedding dimensions.

According to an embodiment of the system, the processing circuitry is further configured to fine-tune parameters of the pretrained LLM, and the training the router and the fine-tuning the parameters of the pretrained LLM are performed via an end-to-end training process.

According to an embodiment of the system, training the router to select, based on the target compression objective, the subnetwork includes parameterizing the subnetwork as a set of network architecture parameters for each of the plurality of network architecture axes, and modeling at least one network architecture parameter of the set of network architecture parameters as: a continuous approximation of a categorical distribution using Gumbel Softmax, or a Bernoulli variable. According to at least one embodiment, the set of network architecture parameters includes the parameters

$${D}^{j} , {N}_{A}^{j} , {H}^{j} , and {λ}_{i}^{j} ,$$

where D^{j} is a number of hidden layer neurons of MLP sub-blocks,

$${N}_{A}^{j}$$

is a number of attention heads of MHA sub-blocks, H^{j} is a number of embedding dimensions of an embedding space, and

$${λ}_{i}^{j}$$

is a set of binary scalers, for i=1, . . . , N, where N is a number of transformer blocks in the pretrained LLM, and D^{j},

$${N}_{A}^{j} ,$$

and H^{j} are modeled as continuous distributions using Gumbel Softmax and each

$${λ}_{i}^{j}$$

is modeled as a Bernoulli variable.

According to an embodiment of the system, the training the router to select, based on the target compression objective, the subnetwork is performed for a set of specified target parameter budgets.

According to an embodiment of the system, the plurality of transformer blocks of the subnetwork include at least one modulation head configured to generate, based on the selected subnetwork, a scale vector and/or a shift vector.

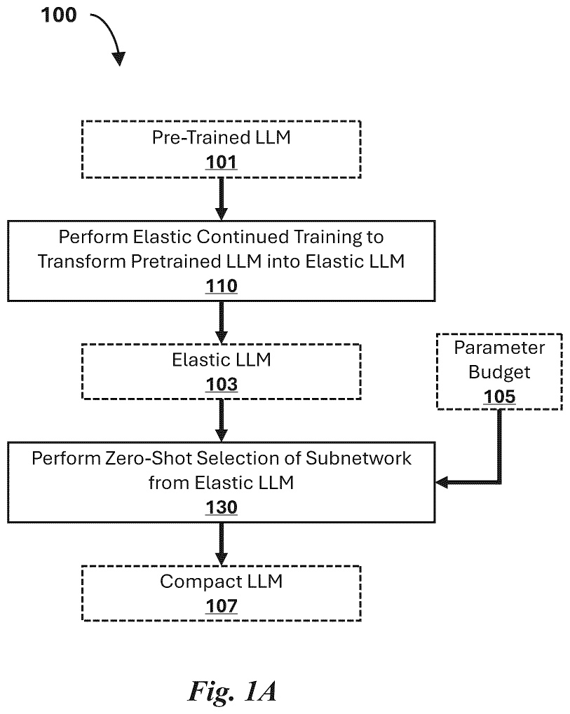

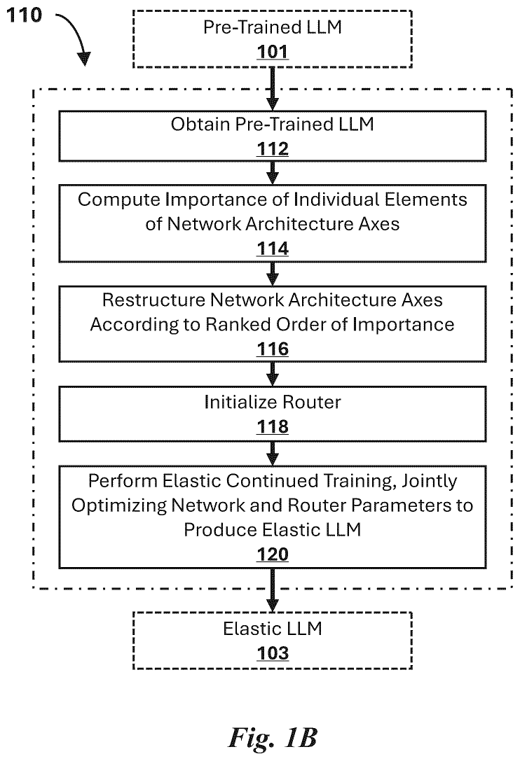

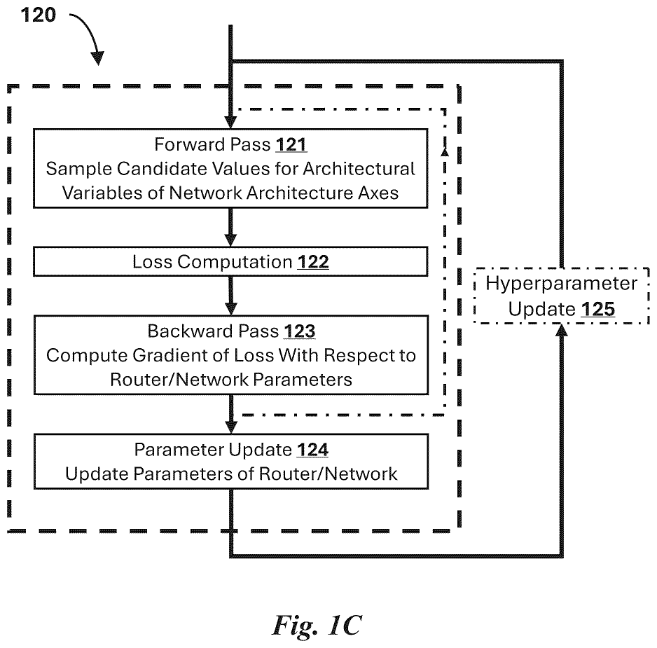

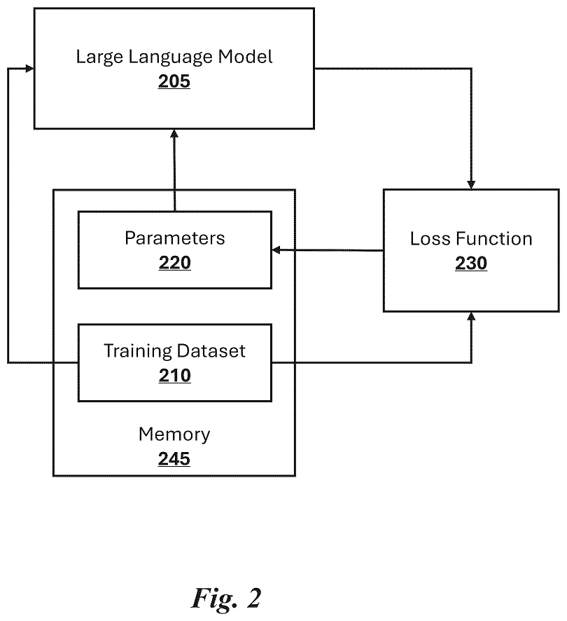

FIG. 1A illustrates a flowchart of a method 100 for continued training of a pretrained neural network to produce an elastic neural network and for zero-shot generation of a compact neural network from the elastic neural network, in accordance with an embodiment. Each block of method 100, described herein, comprises a computing process that may be performed using any combination of hardware, firmware, and/or software. For instance, various functions may be carried out by a processor executing instructions stored in memory. The method may also be embodied as computer-usable instructions stored on computer storage media. The method may be provided by a standalone application, a service or hosted service (standalone or in combination with another hosted service), or a plug-in to another product, to name a few. In addition, method 100 is described, by way of example, with respect to the system of FIG. 2. However, this method may additionally or alternatively be executed by any one system, or any combination of systems, including, but not limited to, those described herein. Furthermore, persons of ordinary skill in the art will understand that any system that performs method 100 is within the scope and spirit of embodiments of the present disclosure.

Method 100 receives, as input, a pretrained neural network 101 and a target compression objective 105. In one or more embodiments, the target compression objective 105 is or includes one or more of target parameter budget, a target latency budget, etc. Method 100 transforms the pretrained neural network 101 into an elastic neural network 103 and performs, using the elastic neural network 103, zero-shot generation of a compact neural network 107 that satisfies the target compression objective 105. In the embodiment illustrated in FIG. 1A, the pretrained neural network is a pretrained large language model (LLM), the elastic neural network 103 is an elastic LLM, and the compact neural network 107 is a compact LLM. The target parameter budget can be determined, e.g., based on deployment constraints, which may include a combination of memory and compute limitations of a target deployment environment. In at least one embodiment, all layers (i.e., transformer blocks) of compact LLM 107 have a uniform architecture, thereby facilitating hardware acceleration during training and/or inference.

In at least one embodiment, the pretrained LLM 101 includes N transformer blocks. In at least one embodiment, each of the N transformer blocks includes a first layer normalization sub-block, a multi-head attention (MHA) sub-block, a second layer normalization sub-block, and a multi-layer perceptron (MLP) sub-block. In at least one embodiment, the pretrained LLM is configured to receive input with dimensions B (batch size/number of sequences), S (sequence length/number of tokens per sequence), and C (channel/embedding dimension). For example, the input can be a batch of up to B=64 sequences, each sequence having up to S=512 tokens, each token being represented by a C=4096 dimensional embedding vector, though the values of B, S, and C can also be much larger and/or smaller.

In at least one embodiment, the pretrained LLM 101 models language as:

$${LLM}_{( D , {N}_{A} , H , N )} ( x ) = {x}_{N} ,$$

$$\text{where:}$$

$${x}_{i + 1} = ( {MHA}_{( H , {N}_{A} )}^{i} ∘ {MLP}_{( H , D )}^{i} ) ( {x}_{i} ) ,$$

for i=1, . . . , N−1, where D is the intermediate dimension of the MLP layer (i.e., the number of neurons in the hidden layer of the MLP), and N_{A} is the number of attention heads (N_{A}), H is the hidden dimension size (also referred to as the size of the embedding space, i.e., the number of embedding dimensions in the embedding space), and N is the number of transformer blocks. Collectively, the parameters (D, N_{A}, H, N) define a “shape” of pretrained LLM 101.

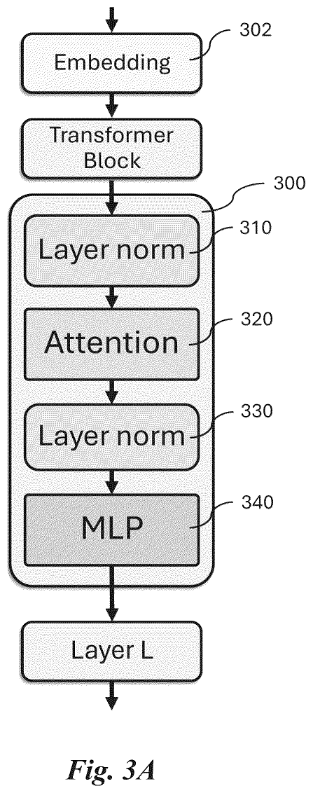

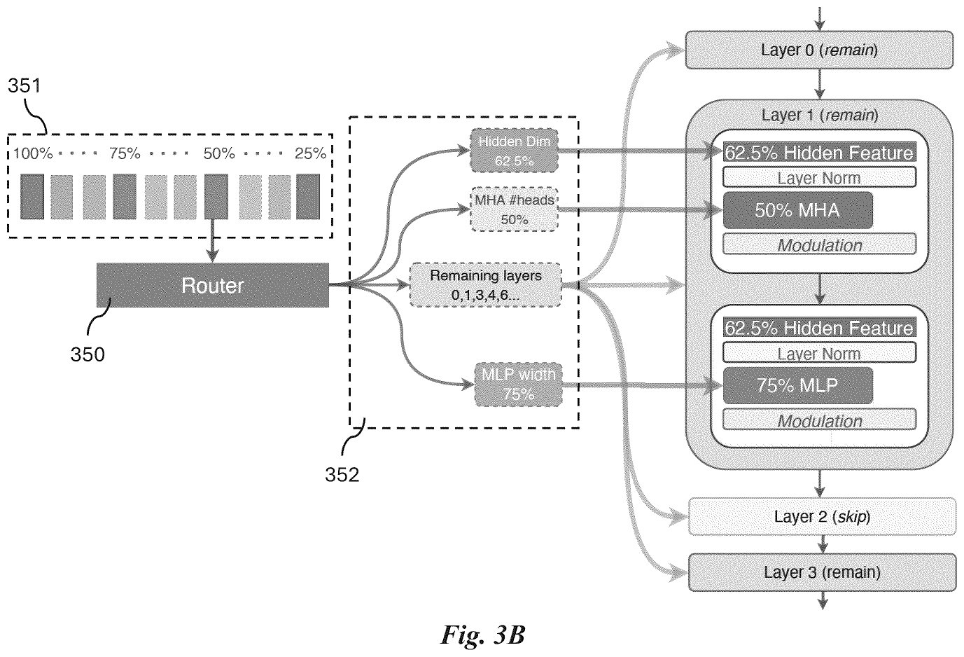

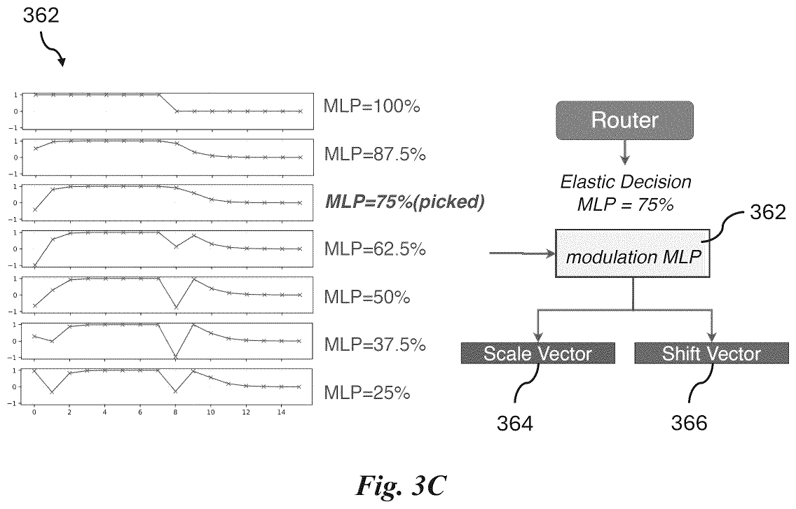

In at least one embodiment, each of the N layers of pretrained LLM 101 is a transformer block 300, including a first normalization sub-block 310, an MHA sub-block 320, a second normalization sub-block 330, and an MLP sub-block 340—provided in the configuration illustrated in FIG. 3A—and being configured to receive input that includes B*S embeddings, e.g., embedding 302.

In at least one embodiment, each of first normalization sub-block 310 and second normalization sub-block 330 are configured to perform a layer normalization operation (LN) on input X, defined as:

$$LN ( X ) = \frac{X - μ}{\sqrt{{σ}^{2} + ϵ}} ⊙ γ + β$$

where μ and σ² represent the mean and variance across the embedding dimension, ϵ is a small value for numerical stability, and γ and β are learnable parameters.

In at least one embodiment, MHA sub-block 320 includes a plurality of attention heads. Each respective attention head of the plurality of attention heads includes a respective set of three different learned weight matrices: (i) a query weight matrix for transforming an input vector into a query vector, (ii) a key weight matrix for transforming an input vector into a key vector, and (iii) a value weight matrix for transforming an input vector into a value vector. In at least one embodiment, each respective attention head generates, using the query, key, and value weight matrices, a respective attention head vector for each token. In at least one embodiment, MHA sub-block 320 further includes a concatenation layer, which concatenates the plurality of attention head vectors that correspond to a particular token to produce, for that token, a concatenated attention head vector. In at least one embodiment, MHA sub-block 320 includes a final linear layer, which includes an additional weight matrix that transforms the concatenated attention head vector corresponding to a particular token into a final MHA layer output vector for the particular token. MHA sub-block 320 provides context-aware representations corresponding to each token, thereby providing the ability to capture both local and long-range relationships and dependencies between different tokens in a tokenized input sequence. Increasing the number of attention heads in the MHA sub-block 320 allows a wider range of relationships and dependencies to be captured, potentially leading to improved model performance for complicated tasks. However, a larger number of attention heads increases the computational costs associated with both training the model and using the model at inference. In at least one embodiment, MHA sub-block 320 performs an MHA operation for an input X as follows:

$$MHA ( X ) = Concat ( {head}_{1} , … {head}_{{N}_{A}} ) \cdot {W}^{O}$$

$${head}_{k} = Attn ( {XW}_{k}^{Q} , {XW}_{k}^{K} , {XW}_{k}^{V} )$$

$$where {W}_{k}^{Q} , {W}_{k}^{K} , {W}_{k}^{V} ∈ , {W}^{O} ∈ .$$

In at least one embodiment, MLP sub-block 340 includes an input layer, an output layer, and a hidden layer. The hidden layer includes a plurality of neurons that provide MLP sub-block 340 with the ability to ascertain complex patterns and relationships in the data it receives, and the width (i.e. the number of neurons in the hidden layer) impacts the capacity of MLP sub-block 340 to learn and generalize from the data. Increasing the width improves the accuracy of the inferences, but also increases the computational costs associated with both training the model and using the model at inference. In at least one embodiment, MLP sub-block 340 performs an MLP operation for an input X as follows:

$$MLP ( X ) = δ ( X \cdot {( {W}^{( 1 )} )}^{T} ) \cdot {W}^{( 2 )}$$

where X denotes the input, and W⁽¹⁾ and W⁽²⁾ are two associated weight matrices in the MLP layer. W⁽¹⁾, W⁽²⁾∈ [symbol] . δ(⋅) refers to the non-linear activation function.

At 110, method 100 performs elastic continued training to transform pretrained LLM 101 into elastic LLM 103. In at least one embodiment, method 100 performs the elastic training at 110 in accordance with the elastic continued training method of FIG. 1B. In at least one embodiment, the elastic LLM 103 has an identical shape as the pretrained LLM 101 but additionally includes a router configured to select, from a number of unique sub-networks, a single sub-network through which to route input, the selected sub-network being adapted to meet a target compression objective (e.g., target compression objective 105, e.g., a target parameter budget), which can be determined, e.g., from user-defined objectives (e.g. latency, memory, accuracy, etc.).

In at least one embodiment, elastic LLM 103 includes N transformer blocks, each including a first layer normalization sub-block, a multi-head attention (MHA) sub-block, a second layer normalization sub-block, and a multi-layer perceptron (MLP) sub-block. In at least one embodiment, elastic LLM 103 is configured to receive input with dimensions B (batch size/number of sequences), S (sequence length/number of tokens per sequence), and C (channel/embedding dimension). In at least one embodiment, each of the N transformer blocks of elastic LLM 103 is a transformer block 300, including a first normalization sub-block 310, an MHA sub-block 320, a second normalization sub-block 330, and an MLP sub-block 340—provided in the configuration illustrated in FIG. 3A—and being configured to receive input that includes B*S embeddings, e.g., embedding 302.

In at least one embodiment, elastic LLM 103 includes a router provided as a neural network, e.g., a compact neural network. In at least one embodiment, the router is a two-layer MLP. In at least one embodiment, the router is configured to select a subnetwork and thereby provide a jth compact LLM that models language as:

$$Elastic - {LLM}_{( {D}^{j} , {N}_{A}^{j} , {H}^{j} , {N}^{j} )} ( x ; {λ}^{j} ) = {x}_{N} ,$$

$$where$$

$${x}_{i + 1} = {λ}_{i}^{j} ( {MHA}_{( {H}^{j} , {N}_{A}^{j} )}^{i} ∘ {MLP}_{( {H}^{j} , {D}^{j} )}^{i} ) ( {x}_{i} ) ,$$

for i=1, . . . , N−1, where D^{j} is the intermediate dimension of the MLP layer, and

$${N}_{A}^{j}$$

is the number of attention heads (N_{A}), H^{j} is the number of embedding dimensions of the embedding space, and N^{j} is the number of transformer blocks. Collectively, the parameters

$$( {D}^{j} , {N}_{A}^{j} , {H}^{j} , {N}^{j} )$$

define a “shape” of the jth compact LLM generated from elastic LLM 103.

$${λ}_{i}^{j}$$

is a binary scaler, controlling whether the ith transformer block (or layer) in the jth compact LLM is skipped

$$( {λ}_{i}^{j} = 0 )$$

or not skipped

$$( {λ}_{i}^{j} = 1 ) ,$$

and is the i-th item of λ^{j}, where

$${\sum }_{i} {λ}_{i}^{j} = {N}^{j} .$$

The MHA sub-blocks of the jth compact LLM are defined as:

$${MHA}_{( {H}^{j} , {N}_{A}^{j} )}^{i} ( {x}_{i} ) = Concat ( {head}_{1} , … {head}_{{N}_{A}^{j}} ) \cdot ( {I}_{{N}_{A}^{j} C} {W}^{O} ) ,$$

where

$${head}_{k} = Attn ( {x}_{i} {I}_{{H}^{j}} {W}_{k}^{Q} , {x}_{i} {I}_{{H}^{j}} {W}_{k}^{K} , {x}_{i} {I}_{{H}^{j}} {W}_{k}^{V} ) .$$

The elastic MLP sub-blocks of the jth compact LLM are defined as:

$${MLP}_{( {H}^{j} , {D}^{j} )}^{i} ( {x}_{i} ) = σ ( {x}_{i} \cdot {( {I}_{{D}^{j}} {W}^{( 1 )} {I}_{{H}^{j}} )}^{T} ) \cdot ( {I}_{{D}^{j}} {W}^{( 2 )} {I}_{{H}^{j}} ) .$$

I_{D}_{^{j}}∈ [symbol] I_{H}_{^{j}}∈ [symbol] , and

$${I}_{{N}_{A}^{j} C} ∈$$

are diagonal matrices with the first D^{j}, H^{j}, and

$${N}_{A}^{j} C$$

diagonal elements equal to 1 and the remainder equal to 0, respectively. C denotes the size of a single head. In this manner, the jth compact LLM utilizes only the first H^{j} hidden features, the first D^{j} MLP intermediate neurons, and the first

$${N}_{A}^{j}$$

attention heads. D^{j}, H^{j}, and

$${N}_{A}^{j}$$

are constrained such that D^{j}<D, H^{j}<H, and

$${N}_{A}^{j} < {N}_{A} . {W}^{( 1 )} and {W}^{( 2 )}$$

are weight matrices associated with MLP layers, with W⁽¹⁾, W⁽²⁾∈ [symbol] . σ(⋅) refers to the non-linear activation function. W^{Q,i}, W^{K,i}, W^{V,i}∈ [symbol] and W^{O}∈ [symbol] . During implementation, the diagonal matrices I can be replaced with one or more slicing operators.

At 130, method 100 performs zero-shot selection of a subnetwork from elastic LLM 103 to generate a compact LLM 107 that satisfies the target compression objective 105. In at least one embodiment, a router of elastic LLM 103 processes the target compression objective 105 to determine parameters

$$( {D}^{j} , {N}_{A}^{j} , {H}^{j} , {N}^{j} )$$

for compact LLM 107, and the lowest-ranked D−D^{j} hidden layer neurons, the lowest ranked

$${N}_{A} - {N}_{A}^{j}$$

attention heads, the lowest ranked H−H^{j} embedding dimensions, and the lowest ranked N^{j}−N transformer blocks are sliced from elastic LLM 103 to generate compact LLM 107 at 130. In at least one embodiment, the target compression objective 105 corresponds to a target parameter budget seen by the router of elastic LLM 103 during the elastic continued training performed at 110. In at least one embodiment, the target compression objective 105 varies from the target parameter budgets seen by the router of elastic LLM 103 during the elastic continued training performed at 110, and the router determines parameters

$$( {D}^{j} , {N}_{A}^{j} , {H}^{j} , {N}^{j} )$$

for compact LLM 107 by linearly interpolating between the two nearest target parameter budgets seen during the elastic continued training performed at 110.

FIG. 3B is a schematic diagram illustrating the selection of a subnetwork from elastic LLM to generate a compact LLM that satisfies a target parameter budget. Router 350 receives, as input, a target parameter budget (e.g., the target parameter budge 105 of FIG. 1A), i.e., 50% of the parameters of the pretrained LLM (e.g., the pretrained LLM 101), from a set of target parameter budgets 351. Router 350 determines a set of parameters

$$( {D}^{j} , {N}_{A}^{j} , {H}^{j} , {N}^{j} , {λ}_{i}^{j} )$$

352 for a compact LLM that satisfies the parameter budget. In FIG. 3B, e.g., D^{j}=75% (i.e. the top 75% of neurons ranked by order of importance)

$${N}_{A}^{j} = 50 \%$$

(i.e. the top 50% of attention heads ranked by order of importance), H^{j}=62.5% (i.e. the top 62.5% of embedding dimensions ranked by order of importance),

$${λ}_{0}^{j} = 1 ,$$

$${λ}_{1}^{j} = 1 , and {λ}_{2}^{j} = 0$$

(i.e. a set of transformer blocks is selected that includes the 0^{th}, 1^{st}, 3^{rd}, 4^{th}, and 6^{th} transformer blocks but excludes the 2^{nd} and 5^{th} transformer blocks). The candidates sets of attention heads, neurons, hidden layer dimensions, and layers form the compact (e.g., compact LLM 107).

In at least one embodiment, the router of elastic LLM 103 receives, as input, an embedding vector corresponding to target compression objective 105, and the router of the elastic LLM 103 provides, as output, a candidate set of network architecture elements (i.e. an architectural variable) for each of the plurality of network architecture axes. In at least one embodiment, the target compression objective 105 (denoted bⱼ) is one of a set of “anchor” target parameter budgets [symbol] (i.e., bⱼ∈ [symbol] ) seen during training, and the embedding vector hⱼ received by the router of elastic LLM 103 as input is a one-hot vector determined according to hⱼ=One−Hot(bⱼ), where hⱼ∈ [symbol] . In at least one embodiment, [symbol] ={25%, 50%, 75%, 100%}. In at least one embodiment, the target compression objective 105 (denoted bₖ) is a parameter budget not included in a set of “anchor” target parameter budgets [symbol] (i.e., bₖ∉ [symbol] ) seen during training, and the embedding vector hₖ received by the router of elastic LLM 103 as input is derived by linear interpolating between the nearest target parameter budgets bₙ and bₙ₊₁ in the set of “anchor” target parameter budgets [symbol] (i.e., bₙ, bₙ₊₁∈ [symbol] and bₙ≤bₖ≤bₙ₊₁) according to

$${h}_{k} = \frac{{b}_{n + 1} - {b}_{k}}{{b}_{n + 1} - {b}_{n}} \cdot {h}_{n} + \frac{{b}_{k} - {b}_{n}}{{b}_{n + 1} - {b}_{n}} \cdot {h}_{n + 1} ,$$

where hₙ=One−Hot(bₙ) and hₙ₊₁=One−Hot(bₙ₊₁). By linearly interpolating between nearest target parameter budgets, a smooth transition between the embedding vectors of the known budgets is ensured, and the router of elastic LLM 103 can generalize effectively to any budget target bₖ not seen during training to produce compact LLM 107 for any target parameter budget.

FIG. 1B illustrates a flowchart of a method 110 for elastic continued training for transforming a pretrained neural network into an elastic neural network, in accordance with an embodiment. Each block of method 110, described herein, comprises a computing process that may be performed using any combination of hardware, firmware, and/or software. For instance, various functions may be carried out by a processor executing instructions stored in memory. The method may also be embodied as computer-usable instructions stored on computer storage media. The method may be provided by a standalone application, a service or hosted service (standalone or in combination with another hosted service), or a plug-in to another product, to name a few. In addition, method 110 is described, by way of example, with respect to the system of FIG. 2. However, this method may additionally or alternatively be executed by any one system, or any combination of systems, including, but not limited to, those described herein. Furthermore, persons of ordinary skill in the art will understand that any system that performs method 110 is within the scope and spirit of embodiments of the present disclosure.

At 112, method 110 obtains a pretrained LLM, e.g., pretrained LLM 101 of FIG. 1A. At 114, method 110 computes the importance of each network architecture component of each of a plurality of network architecture axes. The plurality of network architecture axes include an MHA axis, and MLP width axis, an LLM depth axis, and an embedding axis. For the MHA axis, the network architecture components are attention heads; for the MLP width axis, the network architecture components are the neurons in an MLP hidden layer; for the LLM depth axis, the network architecture components are individual layers (i.e. individual transformer blocks stacked sequentially to form an LLM architecture); and for the embedding axis, the network architecture components are the embedding dimensions of the embedding space of the input to each transformer block (i.e., the dimension C of input X having dimensions B, S, and C).

In at least one embodiment, method 110 implements compute-efficient importance estimation at 114 by avoiding computing gradient information when obtaining importance information. The compute-efficient importance estimation is performed using a small calibration dataset and only during inference (i.e. during forward propagation passes). In at least one embodiment, to compute the importance of each attention head, hidden layer neuron, and embedding dimension, activation-based importance scores are computed from activations produced by LayerNorm, MHA, and MLP sub-blocks (e.g., LayerNorm sub-blocks 310 and 330, MHA sub-blocks 320, and MLP sub-blocks 340 of each transformer block 300 of elastic LLM 103), respectively, during forward propagation passes using a small calibration dataset (e.g., consisting of 1024 samples). In at least one embodiment, to compute the importance of each individual layer (e.g., each transformer block 300 of elastic LLM 103), perplexity-based rankings and/or block importance (BI)-based rankings are determined.

In at least one embodiment, method 110 implements compute-efficient importance estimation at 114 for the attention head, hidden layer neuron, and embedding dimensions as:

$${F}_{h e a d}^{( i )} = {\sum }_{B , S} {‖ Attn ( {XW}_{i}^{Q} , X {W}_{i}^{Q} , {XW}_{i}^{Q} ) ‖}_{2}$$

$${F}_{neuron}^{( i )} = {\sum }_{B , S} {X ( {W}^{( 1 ) i} )}^{T}$$

$${F}_{e m b}^{( i )} = {\sum }_{B , S} L {N ( X )}_{i}$$

Where Σ_{B,S} refers to aggregation along the batch and sequence dimensions of input X, and W⁽¹⁾ⁱ refers to the i^{th} row of the first weight matrix W⁽¹⁾ in the MLP layer. In various embodiments, various different aggregation functions are implemented to obtain network-wide importance scores for each of the network architecture components (e.g., attention heads, neurons, and embedding dimensions) along each of plurality of axes (e.g., MHA axis, MLP axis, and embedding axis). In at least one embodiment, for a sequence S, mean importance is used to obtain network-wide importance scores according to

$$\frac{1}{n} {\sum }_{i = 1}^{n} \vert {S}_{i} \vert .$$

In at least one embodiment, for a sequence S, L2 norm is used to obtain network-wide importance scores according to

$$\sqrt{{\sum }_{i = 1}^{n} {S}_{i}^{2}} .$$

In at least one embodiment, for a sequence S, variance is used to obtain network-wide importance scores according to

$$\frac{1}{n} {\sum }_{i = 1}^{n} {( {S}_{i} - \overline{S} )}^{2} .$$

At 116, method 110 restructures the network architecture elements of each of the plurality of network architecture axes according to their ranked order of importance, thereby providing a sorted, pretrained LLM. In at least one embodiment, restructuring the network architecture elements includes sorting attention heads of MHA sub-blocks in order of importance, sorting neurons in hidden layers of MLP sub-blocks in order of importance, and sorting dimensions of the embedding space in order of importance. In at least one embodiment, sorting attention heads of MHA sub-blocks is performed by permuting respective weight matrices in the MHA sub-blocks such that heads are stored in decreasing order of importance for every individual MHA sub-block. In at least one embodiment, sorting neurons of MLP sub-blocks is performed by reordering respective weight matrices in the MLP layers such that neurons are stored in decreasing order of importance for every individual MLP. In at least one embodiment, sorting dimensions of the embedding space in order of importance is performed by reordering respective embedding dimensions such that components of embeddings are provided in decreasing order of importance. In such embodiments, sub-networks can be selected by indexing the first several heads/neurons/embedding dimensions, thus preserving essential knowledge encoded in important channels. In this manner, nested elastic layers are constructed, with neurons/heads/embedding dimensions sorted by importance, such that the first neurons/heads/embedding dimensions are the most important.

At 118, method 110 provides and initializes a router configured to select, from a number of unique sub-networks, a single sub-network through which to route input. In at least one embodiment, the router is a neural network, e.g., a compact neural network. In at least one embodiment, the router is a two-layer MLP.

At 120, method 110 performs elastic continued training to jointly optimize network parameters and router parameters. The elastic continued training is an end-to-end training process that jointly updates parameters for the sorted, pretrained LLM and the router. By updating the parameters of the sorted, pretrained LLM, the sorted, pretrained LLM learns to operate as any one of a number of different subnetworks. By learning the parameters of the router, the router learns to select a subnetwork for a given target compression objective, e.g., a target parameter budget. The subnetwork is selected by selecting a candidate set of network architecture elements for each of the plurality of network architecture axes (i.e. a candidate set of attention heads, a candidate set of neurons, a candidate set of hidden layer dimensions, and a candidate set of transformer blocks).

In at least one embodiment, the elastic continued training performed at 120 trains the router to select parameters

$$( {D}^{j} , {N}_{A}^{j} , {H}^{j} , {N}^{j} )$$

and thereby select the subnetwork for a target parameter budget bⱼ, defined as a percentage of remaining parameters relative to the total number of parameters of the sorted, pretrained LLM. In at least one embodiment, the elastic continued training performed at 120 uses the following objective function:

$$■ ( min ⊤ ( ( {D}^{∧} j , {N\_A}^{∧} j , {H}^{∧} j , {N}^{∧} j , {λ}^{∧} j ) ) 𝔼\_ ( x \sim p ( x ) ) [ ℒ\_ ( ( {D}^{∧} j , {N \_ A}^{∧} j , {H}^{∧} j , {N}^{∧} j ) ) ( x ; {λ}^{∧} j ) ] , @ “ s . t . ” 𝒫 ( {D}^{∧} j , {N \_ A}^{∧} j , {H}^{∧} j , {N}^{∧} j , {λ}^{∧} j ) \leq b \_ j \cdot 𝒫 ( D , N \_ A , H , N , 1 \_N ) , {( @ D )}^{∧} j ∈ 𝒟 , {N \_ A}^{∧} j ∈ 𝒩\_ A , {H}^{∧} j ∈ ℋ , {N}^{∧} j ∈ 𝒩 , )$$

where

$${ℒ}_{( {D}^{j} , {N}_{A}^{j} , {H}^{j} , {N}^{j} )} ( x ; {λ}^{j} )$$

is the router loss function, [symbol] (⋅) denotes the number of parameters given the network dimensions (i.e., D\hat{ }j, N_A\hat{ }j, H\hat{ }j, N\hat{ }j) and the binary vector for layer skipping (i.e., λ^{j}), [symbol] (D, N_{A}, H, N, 1_{N}) denotes the number of parameters in the original pretrained model. Each of the network dimensions (i.e., D\hat{ }j, N_A\hat{ }j, H\hat{ }j, N\hat{ }j) are selected from the pre-defined sets [symbol] , [symbol] , [symbol] , [symbol] , respectively.

In at least one embodiment, the pre-defined sets [symbol] , [symbol] , [symbol] , [symbol] specify nested candidate sets of embedding dimensions, nested candidate sets of attention heads, nested candidate sets of hidden layer neurons, and nested candidate sets of transformer blocks. In at least one embodiment, [symbol] ={25%, 37.5%, 50%, 62.5%, 75%, 87.5%, 100%}, [symbol] ={25%, 50%, 75%, 100%}, and [symbol] ={50%, 62.5%, 75%, 87.5%, 100%}. In at least one embodiment, for example, the pre-defined set [symbol] specifies K nested candidate sets of hidden layer neurons such that each ith candidate set (i=1, 2, . . . , K) includes

$$i \frac{D}{K}$$

neurons. In at least one embodiment, each MLP sub-block 340 of pretrained LLM 101 includes a hidden layer with 49,152 neurons (sorted 1 through 49,152 by order of importance) and the pre-defined set [symbol] includes four nested candidate sets: a first candidate set including neurons sorted 1 through 12,288, a second candidate set including neurons sorted 1 through 24,576, a third candidate set including neurons sorted 1 through 36,864, and a fourth candidate set including all 49,152 neurons. In at least one embodiment, the pre-defined set [symbol] specifies K nested candidate sets of attention heads such that each ith candidate set (i=1, 2, . . . , N_{A}) includes

$$i \frac{{N}_{A}}{K}$$

attention heads. For example, in at least one embodiment, each MHA sub-block 320 of pretrained LLM 101 includes 32 attention heads (sorted 1 through 32 by order of importance) and the pre-defined set [symbol] specifies four nested candidate sets: a first candidate set including attention heads numbered 1 through 8, a second candidate set including attention heads numbered 1 through 16, a third candidate set including attention heads numbered 1 through 24, and a fourth candidate set including all 32 attention heads.

In at least one embodiment, candidate sets of attention heads, neurons, and hidden state dimensions as continuous approximations of categorical distributions using Gumbel Softmax and models the choice of whether to skip individual layers (e.g., transformer blocks) as Bernoulli variables, thereby enabling end-to-end training of the router. In at least one embodiment, each architectural variable (i.e., the network dimensions (i.e., D\hat{ }j, N_A\hat{ }j, H\hat{ }j, N\hat{ }j) is represented, during the elastic continued training performed at 120, as a categorical distribution and approximated using the Gumbel-Softmax technique, thereby facilitating random sampling. Over the course of training, the temperature and scaling factor are adjusted to facilitate both sufficient randomness and an acceptable convergence speed. In at least one embodiment, the elastic continued training performed at 120 is performed according to the method of FIG. 1C.

FIG. 1C illustrates a flowchart of a method 120A for jointly learning neural network and router parameters, in accordance with an embodiment. Each block of method 120A, described herein, comprises a computing process that may be performed using any combination of hardware, firmware, and/or software. For instance, various functions may be carried out by a processor executing instructions stored in memory. The method may also be embodied as computer-usable instructions stored on computer storage media. The method may be provided by a standalone application, a service or hosted service (standalone or in combination with another hosted service), or a plug-in to another product, to name a few. In addition, method 120 is described, by way of example, with respect to the system of FIG. 2. However, this method may additionally or alternatively be executed by any one system, or any combination of systems, including, but not limited to, those described herein. Furthermore, persons of ordinary skill in the art will understand that any system that performs method 120A is within the scope and spirit of embodiments of the present disclosure.

Method 120A performs a number of training steps (e.g. tₘₐₓeps), each training step including one or more iterations of forward pass 121, loss computation 122, and backward pass 123. In at least one embodiment, each training step corresponds to a batch of training samples, each training sample in the batch being processed via a single training iteration that includes forward pass 121, loss computation 122, and backward pass 123. During each training step of method 120A, a parameter update is performed at 124. In at least one embodiment, each training step corresponds to a batch of training samples processed via a plurality of training iterations and performing the parameter update at 124 based on an average of gradients computed during each training iteration.

During each forward pass 121, candidate values for each architectural variable (i.e., the network dimensions (i.e., D\hat{ }j, N_A\hat{ }j, H\hat{ }j, N\hat{ }j) and the binary vector for layer skipping (i.e.,

$$\{ {λ}_{i}^{j} , i ∈ [ 0 , N ] \} ) )$$

are sampled, a training sample is processed by the resulting compact LLM, and a compact LLM prediction is generated as output. The candidate values for each architectural variable are sampled from categorical distributions reparameterized with Gumbel noise according to:

$$P ( {D}^{j} = {m}_{d} ) = \frac{exp ( \frac{κ log π ( {D}^{j} = {m}_{d} ) + {g}_{d}}{τ} )}{{\sum }_{m ∈ 𝒟} exp ( \frac{κ log π ( {D}^{j} = m ) + g}{τ} )} ,$$

$$P ( {N}_{A}^{j} = {m}_{a} ) = \frac{exp ( \frac{κ log π ( {N}_{A}^{j} = {m}_{a} ) + {g}_{a}}{τ} )}{{\sum }_{m ∈ {𝒩}_{A}} exp ( \frac{κ log π ( {N}_{A}^{j} = m ) + g}{τ} )} ,$$

$$P ( {H}^{j} = {m}_{h} ) = \frac{exp ( \frac{κ log π ( {H}^{j} = {m}_{h} ) + {g}_{h}}{τ} )}{{\sum }_{m ∈ ℋ} exp ( \frac{κ log π ( {H}^{j} = m ) + g}{τ} )} , and$$

$$P ( {λ}_{i}^{j} = {m}_{λ} ) = \frac{exp ( \frac{κ log π ( {λ}_{i}^{j} = {m}_{λ} ) + {g}_{λ}}{τ} )}{{\sum }_{m ∈ 𝒩} exp ( \frac{κ log π ( {λ}_{i}^{j} = m ) + g}{τ} )} ,$$

where g_{d}, gₐ, gₕ, and g_{λ} are samples from the Gumbel(0,1) distribution, τ is a temperature parameter that controls the smoothness of the approximation, and κ is the scaling factor that balances the relative magnitude of logits and Gumbel noises. As τ→0, the distribution approaches a one-hot vector, allowing the router to make discrete choices. The router, with parameters θ_{R}, outputs given an input vector hⱼ corresponding to a target parameter budget bⱼ, un-normalized log-probabilities for each network architecture axis, i.e.:

$$log π ( {D}^{j} = {m}_{d} ) = {MLP}_{D} ( {h}_{j} ) , log π ( {H}^{j} = {m}_{h} ) = {MLP}_{H} ( {h}_{j} ) , log π ( {N}_{A}^{j} = {m}_{a} ) = {MLP}_{{N}_{A}} ( {h}_{j} ) , and log π ( {λ}_{i}^{j} = {m}_{λ} ) = {MLP}_{{λ}_{i}} ( {h}_{j} ) .$$

During loss computation 122 of each training iteration, method 120A computes, using a loss function [symbol] , a loss. In at least one embodiment, the loss is computed at 122 using the loss function:

$$ℒ = {\sum }_{j} {ℒ}_{R} ( {x}_{j} ; θ , {θ}_{R} , j ) + {ℒ}_{B} ( {θ}_{R} , j ) ,$$

$$where$$

$${ℒ}_{R} ( x ; θ , {θ}_{R} , j ) = {𝔼}_{( {D}^{j} , {N}_{A}^{j} , {H}^{j} , {N}^{j} , {λ}^{j} ) ∼ {𝒬}_{{θ}_{R}} ( {b}_{j} )} [ {ℒ}_{( {D}^{j} , {N}_{A}^{j} , {H}^{j} , {N}^{j} )} ( x ; θ , {λ}^{j} ) ] , and$$

$${ℒ}_{B} ( {θ}_{R} , j ) = max ( {𝔼}_{( {D}^{j} , {N}_{A}^{j} , {H}^{j} , {N}^{j} , {λ}^{j} ) ∼ {𝒬}_{{θ}_{R}} ( {b}_{j} )} 𝒫 ( {D}^{j} , {N}_{A}^{j} , {H}^{j} , {N}^{j} , {λ}^{j} ) - {b}_{j} \cdot {𝒫}_{full} , 0 ) ,$$

where [symbol] _{R} is the router loss, [symbol] _{B} is an additional loss term that ensures that the sampled sub-network adheres to the parameter budget constraint, θ_{R} denotes the parameters of the router, θ denotes the parameters of the sorted, pretrained LLM (e.g., the sorted, pretrained LLM produced at 116 of method 110) [symbol] _{θ}_{_{R}} indicates that the architectural choices

$$( {D}^{j} , {N}_{A}^{j} , {H}^{j} , {N}^{j} , {λ}^{j} )$$

are sampled from the probability distributions modeled by the router for budget target bⱼ, and [symbol] _{full}= [symbol] (D, N_{A}, H, N, 1_{N}). During each backward pass 123, gradients (of the loss computed at 122) with respect to the parameters θ_{R} and θ are computed. The gradient of the loss, with respect to any particular parameter θ_{R} and θ, indicates a direction and relative magnitude of an adjustment to that particular parameter θ_{R} and θ that will reduce the value of the loss. During parameter update 124, the process 120 updates—using gradients calculated during backward pass 123, the parameters θ_{R} and θ. In at least one embodiment, the parameters θ_{R} and θ parameters θ_{R} and θ are updated using a gradient descent optimizer that utilizes momentum, adaptive learning rates, or adaptive moments (e.g. AdaGrad, RMSProp, LARS, Adam). In at least one embodiment, the parameter update at 124 is performed to satisfy the learning objective

$$min ⊤ ( ( {D}^{∧} j , {N \_ A}^{∧} j , {H}^{∧} j , {N}^{∧} j , {λ}^{∧} j ) ) 𝔼\_ ( x \sim p ( x ) ) [ ℒ\_ ( ( {D}^{∧} j , {N \_ A}^{∧} j , {H}^{∧} j , {N}^{∧} j ) ) ( x ; {λ}^{∧} j ) ] .$$

Following completion of the parameter update 124 of a particular training step, method 120A may optionally update one or more hyperparameters at 125 prior to performing a subsequent training step. In at least one embodiment, the temperature τ and/or the scaling factor κ are modified after every training step. In at least one embodiment, the temperature τ and the scaling factor κ are modified at intervals of a predetermined number of training steps. In at least one embodiment, the temperature τ and the scaling factor κ are modified according to predetermined schedules. In at least one embodiment, the value of the scaling factor is increased linearly increased. In at least one embodiment, the value of the temperature is decreased exponentially. Following the completion of the parameter update at 124 and the optional hyperparameter update at 125, the process proceeds to perform a forward pass 121 of a subsequent training step.

In at least one embodiment, elastic continued training at 120 of method 110A and/or the method 120A implement policy-aware modulation by training learnable modulation heads embedded in the sorted, pretrained LLM. The policy aware modulation technique allows for recovery of accuracy surrendered as a result of constraining all subnetworks to use the same weights. The learnable modulation heads are positioned after MHA sub-blocks and MLP sub-blocks, and parameters of the learnable modulation heads are learned in conjunction with the router parameters and the parameters of the sorted, pretrained LLM. In at least one embodiment, a learning rate for the learnable modulation heads is different from a learning rate provided for the router parameters and the parameters of the sorted, pretrained LLM.

In at least one embodiment, each learnable modulation head is a lightweight MLP. The learnable modulation heads receive, as input, a candidate set selection made by the router (i.e. a selection of a candidate set of attention heads or a selection of a candidate set of neurons) and generate, as output, a scale vector and a shift vector. The scale vector and the shift vector are used to transform—i.e. modulate—the outputs of the preceding MHA or MLP sub-block. By training the learnable modulation heads, a degree of accuracy lost by constraining the LLM to use of the same weights for all possible sub-networks can be recovered. In at least one embodiment, for example, a selected sub-network includes eₖ hidden layer neurons for MLP sub-blocks, and the output of each MLP sub-block is condition on eₖ. In at least one embodiment, a sinusoidal embedding of eₖ and a learnable, compact MLP are provided to generate modulation vectors for scaling and shifting. The modulation vectors transform the output of the elastic MLP y according to y\hat{ }=y·MLP_{scale}(Emb(eₖ))+MLP_{shift}(Emb(eₖ)).

FIG. 3C illustrates an example of implementing policy aware modulation within an MLP sub-block of an LLM. As illustrated in FIG. 3C, the scale vector and shift vector modulate the output of the candidate set of neurons (i.e. the top 75% of neurons by order of importance)—and do so in a manner that is dependent on the selection of that specific candidate set of neurons. FIG. 3C illustrates sinusoidal embeddings 360 corresponding to different candidate sets of neurons, which are passed through a modulation MLP 362 to generate scale vector 364 and shift vector 366.

More illustrative information will now be set forth regarding various optional architectures and features with which the foregoing framework may be implemented, per the desires of the user. It should be strongly noted that the following information is set forth for illustrative purposes and should not be construed as limiting in any manner. Any of the following features may be optionally incorporated with or without the exclusion of other features described.

FIG. 2 illustrates a block diagram of an example configuration for continued training of a pretrained neural network to produce an elastic neural network and for zero-shot generation of a compact neural network from the elastic neural network, in accordance with an embodiment. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory. Furthermore, persons of ordinary skill in the art will understand that any system that performs the operations of the system 200 is within the scope and spirit of embodiments of the present disclosure.

The training configuration includes a large language model (LLM) 205, e.g., the pretrained LLM 101. The training configuration can be used to perform, e.g., the elastic continued training for transforming the pretrained LLM 101 into the elastic LLM 103. Training inputs provided in training dataset 210 are provided to LLM 101 to generate predictions (outputs). A loss function 230 is evaluated using ground truth from training dataset 210 and the predictions generated by LLM 205 to compute parameter updates for optimization.

### Exemplary Computing System

Systems with multiple GPUs and CPUs are used in a variety of industries as developers expose and leverage more parallelism in applications such as artificial intelligence computing. High-performance GPU-accelerated systems with tens to many thousands of compute nodes are deployed in data centers, research facilities, and supercomputers to solve ever larger problems. As the number of processing devices within the high-performance systems increases, the communication and data transfer mechanisms need to scale to support the increased bandwidth.

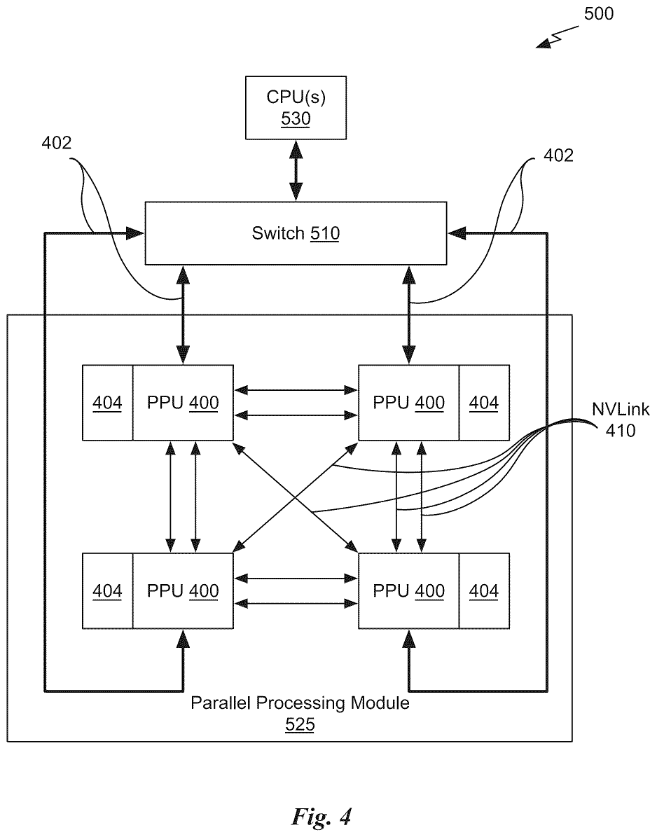

FIG. 4 is a conceptual diagram of a processing system 500 implemented using multiple PPUs 400, in accordance with an embodiment. The exemplary system 500 may utilized as a particular node—or portion thereof—in the above-described multi-node computing systems. In addition to the multiple PPUs 400, the processing system 500 includes a CPU 530, switch 510, and respective memories 404 for the PPUs 400.

Each parallel processing unit (PPU) 400 may include hundreds or thousands of cores that are capable of handling hundreds or thousands of software threads simultaneously. The PPUs 400 may generate pixel data for output images in response to rendering commands (e.g., rendering commands from the CPU(s) 530 received via a host interface). The PPUs 400 may include graphics memory, such as display memory, for storing pixel data or any other suitable data, such as GPU data. The display memory may be included as part of the memory 404. The PPUs 400 may include two or more GPUs operating in parallel (e.g., via a link). The link may directly connect the GPUs (e.g., using NVLINK 410) or may connect the GPUs through a switch (e.g., using switch 510). When combined together, each PPU 400 may generate pixel data or GPGPU data for different portions of an output or for different outputs (e.g., a first PPU for a first image and a second PPU for a second image). Each PPU 400 may include its own memory 404, or may share memory with other PPUs 400.

The PPUs 400 may each include, and/or be configured to perform functions of, one or more processing cores and/or components thereof, such as Tensor Cores (TCs), Tensor Processing Units (TPUs), Pixel Visual Cores (PVCs), Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The NVLink 410 provides high-speed communication links between each of the PPUs 400. Although a particular number of NVLink 410 and interconnect 402 connections are illustrated in FIG. 4, the number of connections to each PPU 400 and the CPU 530 may vary. The switch 510 interfaces between the interconnect 402 and the CPU 530. The PPUs 400, memories 404, and NVLinks 410 may be situated on a single semiconductor platform to form a parallel processing module 525. In an embodiment, the switch 510 supports two or more protocols to interface between various different connections and/or links.

In another embodiment (not shown), the NVLink 410 provides one or more high-speed communication links between each of the PPUs 400 and the CPU 530 and the switch 510 interfaces between the interconnect 402 and each of the PPUs 400. The PPUs 400, memories 404, and interconnect 402 may be situated on a single semiconductor platform to form a parallel processing module 525. In yet another embodiment (not shown), the interconnect 402 provides one or more communication links between each of the PPUs 400 and the CPU 530 and the switch 510 interfaces between each of the PPUs 400 using the NVLink 410 to provide one or more high-speed communication links between the PPUs 400. In another embodiment (not shown), the NVLink 410 provides one or more high-speed communication links between the PPUs 400 and the CPU 530 through the switch 510. In yet another embodiment (not shown), the interconnect 402 provides one or more communication links between each of the PPUs 400 directly. One or more of the NVLink 410 high-speed communication links may be implemented as a physical NVLink interconnect or either an on-chip or on-die interconnect using the same protocol as the NVLink 410.

In the context of the present description, a single semiconductor platform may refer to a sole unitary semiconductor-based integrated circuit fabricated on a die or chip. It should be noted that the term single semiconductor platform may also refer to multi-chip modules with increased connectivity which simulate on-chip operation and make substantial improvements over utilizing a conventional bus implementation. Of course, the various circuits or devices may also be situated separately or in various combinations of semiconductor platforms per the desires of the user. Alternately, the parallel processing module 525 may be implemented as a circuit board substrate and each of the PPUs 400 and/or memories 404 may be packaged devices. In an embodiment, the CPU 530, switch 510, and the parallel processing module 525 are situated on a single semiconductor platform.

In an embodiment, the signaling rate of each NVLink 410 is 20 to 25 Gigabits/second and each PPU 400 includes six NVLink 410 interfaces (as shown in FIG. 4, five NVLink 410 interfaces are included for each PPU 400). Each NVLink 410 provides a data transfer rate of 25 Gigabytes/second in each direction, with six links providing 400 Gigabytes/second. The NVLinks 410 can be used exclusively for PPU-to-PPU communication as shown in FIG. 4, or some combination of PPU-to-PPU and PPU-to-CPU, when the CPU 530 also includes one or more NVLink 410 interfaces.

In an embodiment, the NVLink 410 allows direct load/store/atomic access from the CPU 530 to each PPU's 400 memory 404. In an embodiment, the NVLink 410 supports coherency operations, allowing data read from the memories 404 to be stored in the cache hierarchy of the CPU 530, reducing cache access latency for the CPU 530. In an embodiment, the NVLink 410 includes support for Address Translation Services (ATS), allowing the PPU 400 to directly access page tables within the CPU 530. One or more of the NVLinks 410 may also be configured to operate in a low-power mode.

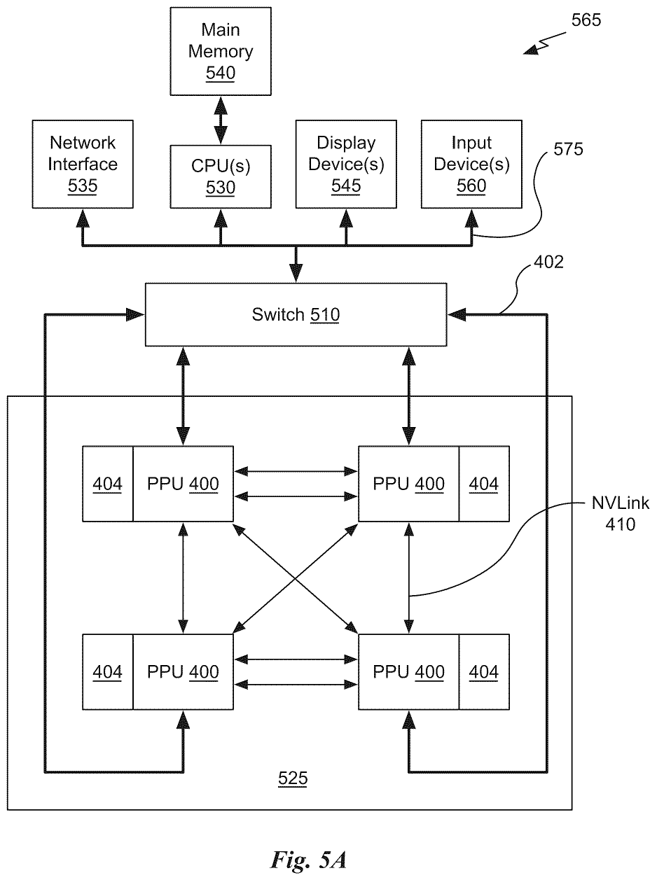

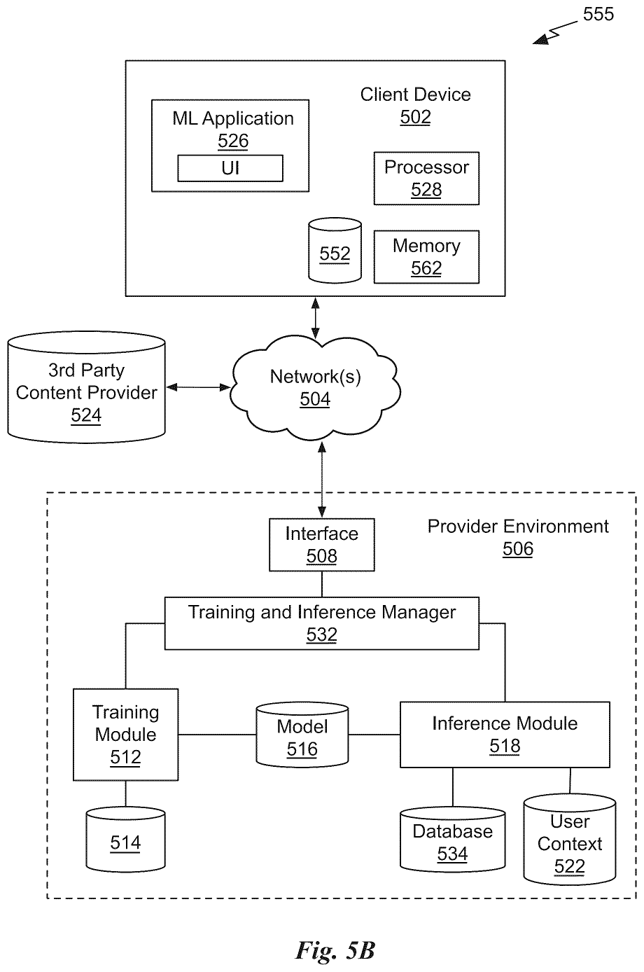

FIG. 5A illustrates an exemplary system 565 in which the various architecture and/or functionality of the various previous embodiments may be implemented. As shown, a system 565 is provided including at least one central processing unit 530 that is connected to a communication bus 575. The communication bus 575 may directly or indirectly couple one or more of the following devices: main memory 540, network interface 535, CPU(s) 530, display device(s) 545, input device(s) 560, switch 510, and parallel processing system 525. The communication bus 575 may be implemented using any suitable protocol and may represent one or more links or busses, such as an address bus, a data bus, a control bus, or a combination thereof. The communication bus 575 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, HyperTransport, and/or another type of bus or link. In some embodiments, there are direct connections between components. As an example, the CPU(s) 530 may be directly connected to the main memory 540. Further, the CPU(s) 530 may be directly connected to the parallel processing system 525. Where there is direct, or point-to-point connection between components, the communication bus 575 may include a PCIe link to carry out the connection. In these examples, a PCI bus need not be included in the system 565.

Although the various blocks of FIG. 5A are shown as connected via the communication bus 575 with lines, this is not intended to be limiting and is for clarity only. For example, in some embodiments, a presentation component, such as display device(s) 545, may be considered an I/O component, such as input device(s) 560 (e.g., if the display is a touch screen). As another example, the CPU(s) 530 and/or parallel processing system 525 may include memory (e.g., the main memory 540 may be representative of a storage device in addition to the parallel processing system 525, the CPUs 530, and/or other components). In other words, the computing device of FIG. 5A is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 5A.

The system 565 also includes a main memory 540. Control logic (software) and data are stored in the main memory 540 which may take the form of a variety of computer-readable media. The computer-readable media may be any available media that may be accessed by the system 565. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the main memory 540 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by system 565. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

Computer programs, when executed, enable the system 565 to perform various functions. The CPU(s) 530 may be configured to execute at least some of the computer-readable instructions to control one or more components of the system 565 to perform one or more of the methods and/or processes described herein. The CPU(s) 530 may each include one or more cores (e.g., one, two, four, eight, twenty-eight, seventy-two, etc.) that are capable of handling a multitude of software threads simultaneously. The CPU(s) 530 may include any type of processor, and may include different types of processors depending on the type of system 565 implemented (e.g., processors with fewer cores for mobile devices and processors with more cores for servers). For example, depending on the type of system 565, the processor may be an Advanced RISC Machines (ARM) processor implemented using Reduced Instruction Set Computing (RISC) or an x86 processor implemented using Complex Instruction Set Computing (CISC). The system 565 may include one or more CPUs 530 in addition to one or more microprocessors or supplementary co-processors, such as math co-processors.

In addition to or alternatively from the CPU(s) 530, the parallel processing module 525 may be configured to execute at least some of the computer-readable instructions to control one or more components of the system 565 to perform one or more of the methods and/or processes described herein. The parallel processing module 525 may be used by the system 565 to render graphics (e.g., 3D graphics) or perform general purpose computations. For example, the parallel processing module 525 may be used for General-Purpose computing on GPUs (GPGPU). In embodiments, the CPU(s) 530 and/or the parallel processing module 525 may discretely or jointly perform any combination of the methods, processes and/or portions thereof.

The system 565 also includes input device(s) 560, the parallel processing system 525, and display device(s) 545. The display device(s) 545 may include a display (e.g., a monitor, a touch screen, a television screen, a heads-up-display (HUD), other display types, or a combination thereof), speakers, and/or other presentation components. The display device(s) 545 may receive data from other components (e.g., the parallel processing system 525, the CPU(s) 530, etc.), and output the data (e.g., as an image, video, sound, etc.).

The network interface 535 may enable the system 565 to be logically coupled to other devices including the input devices 560, the display device(s) 545, and/or other components, some of which may be built in to (e.g., integrated in) the system 565. Illustrative input devices 560 include a microphone, mouse, keyboard, joystick, game pad, game controller, satellite dish, scanner, printer, wireless device, etc. The input devices 560 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the system 565. The system 565 may be include depth cameras, such as stereoscopic camera systems, infrared camera systems, RGB camera systems, touchscreen technology, and combinations of these, for gesture detection and recognition. Additionally, the system 565 may include accelerometers or gyroscopes (e.g., as part of an inertia measurement unit (IMU)) that enable detection of motion. In some examples, the output of the accelerometers or gyroscopes may be used by the system 565 to render immersive augmented reality or virtual reality.

Further, the system 565 may be coupled to a network (e.g., a telecommunications network, local area network (LAN), wireless network, wide area network (WAN) such as the Internet, peer-to-peer network, cable network, or the like) through a network interface 535 for communication purposes. The system 565 may be included within a distributed network and/or cloud computing environment.

The network interface 535 may include one or more receivers, transmitters, and/or transceivers that enable the system 565 to communicate with other computing devices via an electronic communication network, included wired and/or wireless communications. The network interface 535 may be implemented as a network interface controller (NIC) that includes one or more data processing units (DPUs) to perform operations such as (for example and without limitation) packet parsing and accelerating network processing and communication. The network interface 535 may include components and functionality to enable communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet.

The system 565 may also include a secondary storage (not shown). The secondary storage includes, for example, a hard disk drive and/or a removable storage drive, representing a floppy disk drive, a magnetic tape drive, a compact disk drive, digital versatile disk (DVD) drive, recording device, universal serial bus (USB) flash memory. The removable storage drive reads from and/or writes to a removable storage unit in a well-known manner. The system 565 may also include a hard-wired power supply, a battery power supply, or a combination thereof (not shown). The power supply may provide power to the system 565 to enable the components of the system 565 to operate.

Each of the foregoing modules and/or devices may even be situated on a single semiconductor platform to form the system 565. Alternately, the various modules may also be situated separately or in various combinations of semiconductor platforms per the desires of the user. While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

### Example Network Environments

Network environments suitable for use in implementing embodiments of the disclosure may include one or more client devices, servers, network attached storage (NAS), other backend devices, and/or other device types. The client devices, servers, and/or other device types (e.g., each device) may be implemented on one or more instances of the processing system 500 of FIG. 4 and/or exemplary system 565 of FIG. 5A—e.g., each device may include similar components, features, and/or functionality of the processing system 500 and/or exemplary system 565.

Components of a network environment may communicate with each other via a network(s), which may be wired, wireless, or both. The network may include multiple networks, or a network of networks. By way of example, the network may include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) may provide wireless connectivity.

Compatible network environments may include one or more peer-to-peer network environments—in which case a server may not be included in a network environment—and one or more client-server network environments—in which case one or more servers may be included in a network environment. In peer-to-peer network environments, functionality described herein with respect to a server(s) may be implemented on any number of client devices.

In at least one embodiment, a network environment may include one or more cloud-based network environments, a distributed computing environment, a combination thereof, etc. A cloud-based network environment may include a framework layer, a job scheduler, a resource manager, and a distributed file system implemented on one or more of servers, which may include one or more core network servers and/or edge servers. A framework layer may include a framework to support software of a software layer and/or one or more application(s) of an application layer. The software or application(s) may respectively include web-based service software or applications. In embodiments, one or more of the client devices may use the web-based service software or applications (e.g., by accessing the service software and/or applications via one or more application programming interfaces (APIs)). The framework layer may be, but is not limited to, a type of free and open-source software web application framework such as that may use a distributed file system for large-scale data processing (e.g., “big data”).

A cloud-based network environment may provide cloud computing and/or cloud storage that carries out any combination of computing and/or data storage functions described herein (or one or more portions thereof). Any of these various functions may be distributed over multiple locations from central or core servers (e.g., of one or more data centers that may be distributed across a state, a region, a country, the globe, etc.). If a connection to a user (e.g., a client device) is relatively close to an edge server(s), a core server(s) may designate at least a portion of the functionality to the edge server(s). A cloud-based network environment may be private (e.g., limited to a single organization), may be public (e.g., available to many organizations), and/or a combination thereof (e.g., a hybrid cloud environment).

The client device(s) may include at least some of the components, features, and functionality of the example processing system 500 of FIG. 4 and/or exemplary system 565 of FIG. 5A. By way of example and not limitation, a client device may be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device.

### Machine Learning

Deep neural networks (DNNs) developed on processors, such as the PPU 400 have been used for diverse use cases, from self-driving cars to faster drug development, from automatic image captioning in online image databases to smart real-time language translation in video chat applications. Deep learning is a technique that models the neural learning process of the human brain, continually learning, continually getting smarter, and delivering more accurate results more quickly over time. A child is initially taught by an adult to correctly identify and classify various shapes, eventually being able to identify shapes without any coaching. Similarly, a deep learning or neural learning system needs to be trained in object recognition and classification for it get smarter and more efficient at identifying basic objects, occluded objects, etc., while also assigning context to objects.

At the simplest level, neurons in the human brain look at various inputs that are received, importance levels are assigned to each of these inputs, and output is passed on to other neurons to act upon. An artificial neuron is the most basic model of a neural network. In one example, a neuron may receive one or more inputs that represent various features of an object that the neuron is being trained to recognize and classify, and each of these features is assigned a certain weight based on the importance of that feature in defining the shape of an object.

A deep neural network (DNN) model includes multiple layers of many connected nodes (e.g., neurons, Boltzmann machines, radial basis functions, convolutional layers, etc.) that can be trained with enormous amounts of input data to quickly solve complex problems with high accuracy. In one example, a first layer of the DNN model breaks down an input image of an automobile into various sections and looks for basic patterns such as lines and angles. The second layer assembles the lines to look for higher level patterns such as wheels, windshields, and mirrors. The next layer identifies the type of vehicle, and the final few layers generate a label for the input image, identifying the model of a specific automobile brand.

Once the DNN is trained, the DNN can be deployed and used to identify and classify objects or patterns in a process known as inference. Examples of inference (the process through which a DNN extracts useful information from a given input) include identifying handwritten numbers on checks deposited into ATM machines, identifying images of friends in photos, delivering movie recommendations to over fifty million users, identifying and classifying different types of automobiles, pedestrians, and road hazards in driverless cars, or translating human speech in real-time.

During training, data flows through the DNN in a forward propagation phase until a prediction is produced that indicates a label corresponding to the input. If the neural network does not correctly label the input, then errors between the correct label and the predicted label are analyzed, and the weights are adjusted for each feature during a backward propagation phase until the DNN correctly labels the input and other inputs in a training dataset. Training complex neural networks requires massive amounts of parallel computing performance, including floating-point multiplications and additions that are supported by the PPU 400. Inferencing is less compute-intensive than training, being a latency-sensitive process where a trained neural network is applied to new inputs it has not seen before to classify images, detect emotions, identify recommendations, recognize and translate speech, and generally infer new information.

Neural networks rely heavily on matrix math operations, and complex multi-layered networks require tremendous amounts of floating-point performance and bandwidth for both efficiency and speed. With thousands of processing cores, optimized for matrix math operations, and delivering tens to hundreds of TFLOPS of performance, the PPU 400 is a computing platform capable of delivering performance required for deep neural network-based artificial intelligence and machine learning applications.

Furthermore, images generated applying one or more of the techniques disclosed herein may be used to train, test, or certify DNNs used to recognize objects and environments in the real world. Such images may include scenes of roadways, factories, buildings, urban settings, rural settings, humans, animals, and any other physical object or real-world setting. Such images may be used to train, test, or certify DNNs that are employed in machines or robots to manipulate, handle, or modify physical objects in the real world. Furthermore, such images may be used to train, test, or certify DNNs that are employed in autonomous vehicles to navigate and move the vehicles through the real world. Additionally, images generated applying one or more of the techniques disclosed herein may be used to convey information to users of such machines, robots, and vehicles.

FIG. 5B illustrates components of an exemplary system 555 that can be used to train and utilize machine learning, in accordance with at least one embodiment. As will be discussed, various components can be provided by various combinations of computing devices and resources, or a single computing system, which may be under control of a single entity or multiple entities. Further, aspects may be triggered, initiated, or requested by different entities. In at least one embodiment training of a neural network might be instructed by a provider associated with provider environment 506, while in at least one embodiment training might be requested by a customer or other user having access to a provider environment through a client device 502 or other such resource. In at least one embodiment, training data (or data to be analyzed by a trained neural network) can be provided by a provider, a user, or a third party content provider 524. In at least one embodiment, client device 502 may be a vehicle or object that is to be navigated on behalf of a user, for example, which can submit requests and/or receive instructions that assist in navigation of a device.

In at least one embodiment, requests are able to be submitted across at least one network 504 to be received by a provider environment 506. In at least one embodiment, a client device may be any appropriate electronic and/or computing devices enabling a user to generate and send such requests, such as, but not limited to, desktop computers, notebook computers, computer servers, smartphones, tablet computers, gaming consoles (portable or otherwise), computer processors, computing logic, and set-top boxes. Network(s) 504 can include any appropriate network for transmitting a request or other such data, as may include Internet, an intranet, an Ethernet, a cellular network, a local area network (LAN), a wide area network (WAN), a personal area network (PAN), an ad hoc network of direct wireless connections among peers, and so on.

In at least one embodiment, requests can be received at an interface layer 508, which can forward data to a training and inference manager 532, in this example. The training and inference manager 532 can be a system or service including hardware and software for managing requests and service corresponding data or content, in at least one embodiment, the training and inference manager 532 can receive a request to train a neural network, and can provide data for a request to a training module 512. In at least one embodiment, training module 512 can select an appropriate model or neural network to be used, if not specified by the request, and can train a model using relevant training data. In at least one embodiment, training data can be a batch of data stored in a training data repository 514, received from client device 502, or obtained from a third party provider 524. In at least one embodiment, training module 512 can be responsible for training data. A neural network can be any appropriate network, such as a recurrent neural network (RNN) or convolutional neural network (CNN). Once a neural network is trained and successfully evaluated, a trained neural network can be stored in a model repository 516, for example, that may store different models or networks for users, applications, or services, etc. In at least one embodiment, there may be multiple models for a single application or entity, as may be utilized based on a number of different factors.

In at least one embodiment, at a subsequent point in time, a request may be received from client device 502 (or another such device) for content (e.g., path determinations) or data that is at least partially determined or impacted by a trained neural network. This request can include, for example, input data to be processed using a neural network to obtain one or more inferences or other output values, classifications, or predictions, or for at least one embodiment, input data can be received by interface layer 508 and directed to inference module 518, although a different system or service can be used as well. In at least one embodiment, inference module 518 can obtain an appropriate trained network, such as a trained deep neural network (DNN) as discussed herein, from model repository 516 if not already stored locally to inference module 518. Inference module 518 can provide data as input to a trained network, which can then generate one or more inferences as output. This may include, for example, a classification of an instance of input data. In at least one embodiment, inferences can then be transmitted to client device 502 for display or other communication to a user. In at least one embodiment, context data for a user may also be stored to a user context data repository 522, which may include data about a user which may be useful as input to a network in generating inferences, or determining data to return to a user after obtaining instances. In at least one embodiment, relevant data, which may include at least some of input or inference data, may also be stored to a local database 534 for processing future requests. In at least one embodiment, a user can use account information or other information to access resources or functionality of a provider environment. In at least one embodiment, if permitted and available, user data may also be collected and used to further train models, in order to provide more accurate inferences for future requests. In at least one embodiment, requests may be received through a user interface to a machine learning application 526 executing on client device 502, and results displayed through a same interface. A client device can include resources such as a processor 528 and memory 562 for generating a request and processing results or a response, as well as at least one data storage element 552 for storing data for machine learning application 526.

In at least one embodiment a processor 528 (or a processor of training module 512 or inference module 518) will be a central processing unit (CPU). As mentioned, however, resources in such environments can utilize GPUs to process data for at least certain types of requests. With thousands of cores, GPUs, such as PPU 400 are designed to handle substantial parallel workloads and, therefore, have become popular in deep learning for training neural networks and generating predictions. While use of GPUs for offline builds has enabled faster training of larger and more complex models, generating predictions offline implies that either request-time input features cannot be used or predictions must be generated for all permutations of features and stored in a lookup table to serve real-time requests. If a deep learning framework supports a CPU-mode and a model is small and simple enough to perform a feed-forward on a CPU with a reasonable latency, then a service on a CPU instance could host a model. In this case, training can be done offline on a GPU and inference done in real-time on a CPU. If a CPU approach is not viable, then a service can run on a GPU instance. Because GPUs have different performance and cost characteristics than CPUs, however, running a service that offloads a runtime algorithm to a GPU can require it to be designed differently from a CPU based service.

In at least one embodiment, video data can be provided from client device 502 for enhancement in provider environment 506. In at least one embodiment, video data can be processed for enhancement on client device 502. In at least one embodiment, video data may be streamed from a third party content provider 524 and enhanced by third party content provider 524, provider environment 506, or client device 502. In at least one embodiment, video data can be provided from client device 502 for use as training data in provider environment 506. In at least one embodiment, supervised and/or unsupervised training can be performed by the client device 502 and/or the provider environment 506. In at least one embodiment, a set of training data 514 (e.g., classified or labeled data) is provided as input to function as training data.

In at least one embodiment, training data can include instances of at least one type of object for which a neural network is to be trained, as well as information that identifies that type of object. In at least one embodiment, training data might include a set of images that each includes a representation of a type of object, where each image also includes, or is associated with, a label, metadata, classification, or other piece of information identifying a type of object represented in a respective image. Various other types of data may be used as training data as well, as may include text data, audio data, video data, and so on. In at least one embodiment, training data 514 is provided as training input to a training module 512. In at least one embodiment, training module 512 can be a system or service that includes hardware and software, such as one or more computing devices executing a training application, for training a neural network (or other model or algorithm, etc.). In at least one embodiment, training module 512 receives an instruction or request indicating a type of model to be used for training, in at least one embodiment, a model can be any appropriate statistical model, network, or algorithm useful for such purposes, as may include an artificial neural network, deep learning algorithm, learning classifier, Bayesian network, and so on. In at least one embodiment, training module 512 can select an initial model, or other untrained model, from an appropriate repository 516 and utilize training data 514 to train a model, thereby generating a trained model (e.g., trained deep neural network) that can be used to classify similar types of data, or generate other such inferences. In at least one embodiment where training data is not used, an appropriate initial model can still be selected for training on input data per training module 512.

In at least one embodiment, a model can be trained in a number of different ways, as may depend in part upon a type of model selected. In at least one embodiment, a machine learning algorithm can be provided with a set of training data, where a model is a model artifact created by a training process. In at least one embodiment, each instance of training data contains a correct answer (e.g., classification), which can be referred to as a target or target attribute. In at least one embodiment, a learning algorithm finds patterns in training data that map input data attributes to a target, an answer to be predicted, and a machine learning model is output that captures these patterns. In at least one embodiment, a machine learning model can then be used to obtain predictions on new data for which a target is not specified.

In at least one embodiment, training and inference manager 532 can select from a set of machine learning models including binary classification, multiclass classification, generative, and regression models. In at least one embodiment, a type of model to be used can depend at least in part upon a type of target to be predicted.

### Graphics Processing Pipeline

In an embodiment, the PPU 400 comprises a graphics processing unit (GPU). The PPU 400 is configured to receive commands that specify shader programs for processing graphics data. Graphics data may be defined as a set of primitives such as points, lines, triangles, quads, triangle strips, and the like. Typically, a primitive includes data that specifies a number of vertices for the primitive (e.g., in a model-space coordinate system) as well as attributes associated with each vertex of the primitive. The PPU 400 can be configured to process the graphics primitives to generate a frame buffer (e.g., pixel data for each of the pixels of the display).

An application writes model data for a scene (e.g., a collection of vertices and attributes) to a memory such as a system memory or memory 404. The model data defines each of the objects that may be visible on a display. The application then makes an API call to the driver kernel that requests the model data to be rendered and displayed. The driver kernel reads the model data and writes commands to the one or more streams to perform operations to process the model data. The commands may reference different shader programs to be implemented on the processing units within the PPU 400 including one or more of a vertex shader, hull shader, domain shader, geometry shader, and a pixel shader. For example, one or more of the processing units may be configured to execute a vertex shader program that processes a number of vertices defined by the model data. In an embodiment, the different processing units may be configured to execute different shader programs concurrently. For example, a first subset of processing units may be configured to execute a vertex shader program while a second subset of processing units may be configured to execute a pixel shader program. The first subset of processing units processes vertex data to produce processed vertex data and writes the processed vertex data to the L2 cache and/or the memory 404. After the processed vertex data is rasterized (e.g., transformed from three-dimensional data into two-dimensional data in screen space) to produce fragment data, the second subset of processing units executes a pixel shader to produce processed fragment data, which is then blended with other processed fragment data and written to the frame buffer in memory 404. The vertex shader program and pixel shader program may execute concurrently, processing different data from the same scene in a pipelined fashion until all of the model data for the scene has been rendered to the frame buffer. Then, the contents of the frame buffer are transmitted to a display controller for display on a display device.

Images generated applying one or more of the techniques disclosed herein may be displayed on a monitor or other display device. In some embodiments, the display device may be coupled directly to the system or processor generating or rendering the images. In other embodiments, the display device may be coupled indirectly to the system or processor such as via a network. Examples of such networks include the Internet, mobile telecommunications networks, a WIFI network, as well as any other wired and/or wireless networking system. When the display device is indirectly coupled, the images generated by the system or processor may be streamed over the network to the display device. Such streaming allows, for example, video games or other applications, which render images, to be executed on a server, a data center, or in a cloud-based computing environment and the rendered images to be transmitted and displayed on one or more user devices (such as a computer, video game console, smartphone, other mobile device, etc.) that are physically separate from the server or data center. Hence, the techniques disclosed herein can be applied to enhance the images that are streamed and to enhance services that stream images such as NVIDIA GeForce Now (GFN), Google Stadia, and the like.

### Example Streaming System

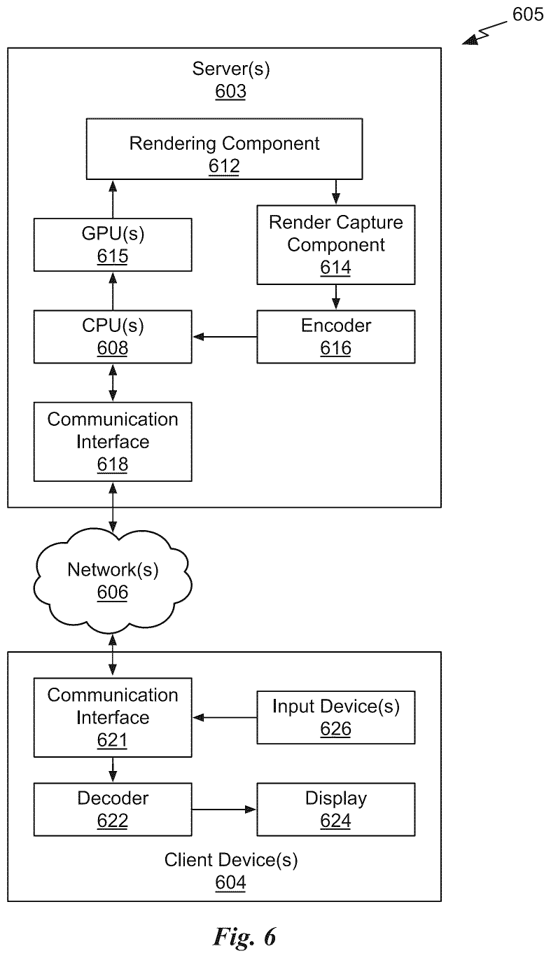

FIG. 6 is an example system diagram for a streaming system 605, in accordance with some embodiments of the present disclosure. FIG. 6 includes server(s) 603 (which may include similar components, features, and/or functionality to the example processing system 500 of FIG. 4 and/or exemplary system 565 of FIG. 5A), client device(s) 604 (which may include similar components, features, and/or functionality to the example processing system 500 of FIG. 4 and/or exemplary system 565 of FIG. 5A), and network(s) 606 (which may be similar to the network(s) described herein). In some embodiments of the present disclosure, the system 605 may be implemented.

In an embodiment, the streaming system 605 is a game streaming system and the server(s) 603 are game server(s). In the system 605, for a game session, the client device(s) 604 may only receive input data in response to inputs to the input device(s) 626, transmit the input data to the server(s) 603, receive encoded display data from the server(s) 603, and display the display data on the display 624. As such, the more computationally intense computing and processing is offloaded to the server(s) 603 (e.g., rendering—in particular ray or path tracing—for graphical output of the game session is executed by the GPU(s) 615 of the server(s) 603). In other words, the game session is streamed to the client device(s) 604 from the server(s) 603, thereby reducing the requirements of the client device(s) 604 for graphics processing and rendering.

For example, with respect to an instantiation of a game session, a client device 604 may be displaying a frame of the game session on the display 624 based on receiving the display data from the server(s) 603. The client device 604 may receive an input to one of the input device(s) 626 and generate input data in response. The client device 604 may transmit the input data to the server(s) 603 via the communication interface 621 and over the network(s) 606 (e.g., the Internet), and the server(s) 603 may receive the input data via the communication interface 618. The CPU(s) 608 may receive the input data, process the input data, and transmit data to the GPU(s) 615 that causes the GPU(s) 615 to generate a rendering of the game session. For example, the input data may be representative of a movement of a character of the user in a game, firing a weapon, reloading, passing a ball, turning a vehicle, etc. The rendering component 612 may render the game session (e.g., representative of the result of the input data) and the render capture component 614 may capture the rendering of the game session as display data (e.g., as image data capturing the rendered frame of the game session). The rendering of the game session may include ray or path-traced lighting and/or shadow effects, computed using one or more parallel processing units—such as GPUs, which may further employ the use of one or more dedicated hardware accelerators or processing cores to perform ray or path-tracing techniques—of the server(s) 603. The encoder 616 may then encode the display data to generate encoded display data and the encoded display data may be transmitted to the client device 604 over the network(s) 606 via the communication interface 618. The client device 604 may receive the encoded display data via the communication interface 621 and the decoder 622 may decode the encoded display data to generate the display data. The client device 604 may then display the display data via the display 624.

It is noted that the techniques described herein may be embodied in executable instructions stored in a computer readable medium for use by or in connection with a processor-based instruction execution machine, system, apparatus, or device. It will be appreciated by those skilled in the art that, for some embodiments, various types of computer-readable media can be included for storing data. As used herein, a “computer-readable medium” includes one or more of any suitable media for storing the executable instructions of a computer program such that the instruction execution machine, system, apparatus, or device may read (or fetch) the instructions from the computer-readable medium and execute the instructions for carrying out the described embodiments. Suitable storage formats include one or more of an electronic, magnetic, optical, and electromagnetic format. A non-exhaustive list of conventional exemplary computer-readable medium includes: a portable computer diskette; a random-access memory (RAM); a read-only memory (ROM); an erasable programmable read only memory (EPROM); a flash memory device; and optical storage devices, including a portable compact disc (CD), a portable digital video disc (DVD), and the like.

The arrangement of components illustrated in the attached Figures are for illustrative purposes and that other arrangements are possible. For example, one or more of the elements described herein may be realized, in whole or in part, as an electronic hardware component. Other elements may be implemented in software, hardware, or a combination of software and hardware. Moreover, some or all of these other elements may be combined, some may be omitted altogether, and additional components may be added while still achieving the functionality described herein. Thus, the subject matter described herein may be embodied in many different variations, and all such variations are contemplated to be within the scope of the claims.

To facilitate an understanding of the subject matter described herein, many aspects are described in terms of sequences of actions. Various actions may be performed by specialized circuits or circuitry, by program instructions being executed by one or more processors, or by a combination of both. The description herein of any sequence of actions is not intended to imply that the specific order described for performing that sequence must be followed. All methods described herein may be performed in any suitable order unless otherwise indicated herein or otherwise clearly contradicted by context.

The use of the terms “a” and “an” and “the” and similar references in the context of describing the subject matter (particularly in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. Furthermore, the foregoing description is for the purpose of illustration only, and not for the purpose of limitation, as the scope of protection sought is defined by the claims as set forth hereinafter together with any equivalents thereof. The use of any and all examples, or exemplary language (e.g., “such as”) provided herein, is intended merely to better illustrate the subject matter and does not pose a limitation on the scope of the subject matter unless otherwise claimed. The use of the term “based on” and other like phrases indicating a condition for bringing about a result, both in the claims and in the written description, is not intended to foreclose any other conditions that bring about that result. No language in the specification should be construed as indicating any non-claimed element as essential to the practice of the invention as claimed.

What is claimed is:

1. A method for transforming a pretrained large language model (LLM) into an elastic LLM, the method comprising:
obtaining the pretrained LLM;
ranking network architecture components of the pretrained LLM for a plurality of network architecture axes; and
training a router to select, based on a target compression objective, a subnetwork comprising a candidate set of network architecture components for one or more of the plurality of network architecture axes,
wherein the subnetwork comprises a plurality of transformer blocks having a uniform architecture.

2. The method of claim 1, wherein the network architecture axes comprise a multi-head attention (MHA) axis, a multi-layer perceptron (MLP) axis, an embedding axis, and an LLM depth axis,
wherein the network architecture components of the MHA axis are attention heads of MHA sub-blocks, wherein the network architecture components of the MLP axis are hidden layer neurons of MLP sub-blocks, wherein the network architecture components of the embedding axis are embedding dimensions of an embedding space, and wherein the network architecture components of the LLM depth axis are transformer blocks.

3. The method of claim 2, wherein the uniform architecture comprises a uniform number of attention heads of MHA sub-blocks, a uniform number of hidden layer neurons of MLP sub-blocks, and a uniform number of embedding dimensions of an embedding space.

4. The method of claim 3, wherein the uniform number of attention heads of MHA sub-blocks is selected from a pre-defined group of nested sets of attention heads, the uniform number of hidden layer neurons of MLP sub-blocks is selected from a pre-defined group of nested sets of hidden layer neurons, and the uniform number of embedding dimensions of the embedding space is selected from a pre-defined group of nested sets of embedding dimensions.

5. The method of claim 3, wherein the pretrained LLM includes N transformer blocks comprising an MHA sub-block with N_{A} attention heads, an MLP sub-block with a hidden layer with D neurons, and an embedding space with H embedding dimensions,
wherein
$${N}_{A}^{j}$$
is the uniform number of attention heads of MHA sub-blocks, D^{j} is the uniform number of hidden layer neurons of MLP sub-blocks, and H^{j} is the uniform number of embedding dimensions of the embedding space,
wherein the subnetwork consists of N^{j} transformer blocks, and
wherein
$${N}_{A}^{j} < {N}_{A} , {D}^{j} < D , {H}^{j} < H , and {N}^{j} < N .$$

6. The method of claim 5, wherein the MHA sub-blocks of the transformer blocks of the subnetwork comprise the
$${N}_{A}^{j}$$
highest ranked attention heads, wherein the MLP sub-blocks of the transformer blocks of the subnetwork comprise the D^{j} highest ranked hidden layer neurons, and wherein the embedding space of the transformer blocks of the subnetwork comprise the H^{j} highest ranked embedding dimensions.

7. The method of claim 1, further comprising fine-tuning parameters of the pretrained LLM, wherein the training the router and the fine-tuning the parameters of the pretrained LLM are performed via an end-to-end training process.

8. The method of claim 1, wherein training the router to select, based on the target compression objective, the subnetwork comprises:
parameterizing the subnetwork as a set of network architecture parameters for each of the plurality of network architecture axes,
modeling at least one network architecture parameter of the set of network architecture parameters as:
a continuous approximation of a categorical distribution using Gumbel Softmax, or
a Bernoulli variable.

9. The method of claim 8, wherein the set of network architecture parameters comprises the parameters
$${D}^{j} , {N}_{A}^{j} , {H}^{j} , and {λ}_{i}^{j} ,$$
wherein where D^{j} is a number of hidden layer neurons of MLP sub-blocks,
$${N}_{A}^{j}$$
is a number of attention heads of MHA sub-blocks, H^{j} is a number of embedding dimensions of an embedding space, and
$${λ}_{i}^{j}$$
is a set of binary scalers, for i=1, . . . , N, where N is a number of transformer blocks in the pretrained LLM, and
wherein
$${D}^{j} , {N}_{A}^{j} ,$$
and H^{j} are modeled as continuous distributions using Gumbel Softmax and each
$${λ}_{i}^{j}$$
is modeled as a Bernoulli variable.

10. The method of claim 1, wherein the training the router to select, based on the target compression objective, the subnetwork is performed for a set of specified target parameter budgets.

11. The method of claim 1, wherein the plurality of transformer blocks of the subnetwork comprise at least one modulation head configured to generate, based on the selected subnetwork, a scale vector and/or a shift vector.

12. A system, comprising:
processing circuitry configured to transform a pretrained large language model (LLM) into an elastic LLM by:
obtaining the pretrained LLM,
ranking network architecture components of the pretrained LLM for a plurality of network architecture axes, and
training a router to select, based on a target compression objective, a subnetwork comprising a candidate set of network architecture components for one or more of the plurality of network architecture axes, wherein the subnetwork comprises a plurality of transformer blocks having a uniform architecture; and
one or more memories configured to store the elastic LLM.

13. The system of claim 12, wherein the network architecture axes comprise a multi-head attention (MHA) axis, a multi-layer perceptron (MLP) axis, an embedding axis, and an LLM depth axis,
wherein the network architecture components of the MHA axis are attention heads of MHA sub-blocks, wherein the network architecture components of the MLP axis are hidden layer neurons of MLP sub-blocks, wherein the network architecture components of the embedding axis are embedding dimensions of an embedding space, and wherein the network architecture components of the LLM depth axis are transformer blocks.

14. The system of claim 13, wherein the uniform architecture comprises a uniform number of attention heads of MHA sub-blocks, a uniform number of hidden layer neurons of MLP sub-blocks, and a uniform number of embedding dimensions of an embedding space.

15. The system of claim 14, wherein the uniform number of attention heads of MHA sub-blocks is selected from a pre-defined group of nested sets of attention heads, the uniform number of hidden layer neurons of MLP sub-blocks is selected from a pre-defined group of nested sets of hidden layer neurons, and the uniform number of embedding dimensions of the embedding space is selected from a pre-defined group of nested sets of embedding dimensions.

16. The system of claim 14, wherein the pretrained LLM includes N transformer blocks comprising an MHA sub-block with N_{A} attention heads, an MLP sub-block with a hidden layer with D neurons, and an embedding space with H embedding dimensions,
wherein
$${N}_{A}^{j}$$
is the uniform number of attention heads of MHA sub-blocks, D^{j} is the uniform number of hidden layer neurons of MLP sub-blocks, and H^{j} is the uniform number of embedding dimensions of the embedding space,
wherein the subnetwork consists of N^{j} transformer blocks, and
wherein
$${N}_{A}^{j} < {N}_{A} , {D}^{j} < D , {H}^{j} < H , and {N}^{j} < N .$$

17. The system of claim 14, wherein the MHA sub-blocks of the transformer blocks of the subnetwork comprise the
$${N}_{A}^{j}$$
highest ranked attention heads, wherein the MLP sub-blocks of the transformer blocks of the subnetwork comprise the D^{j} highest ranked hidden layer neurons, and wherein the embedding space of the transformer blocks of the subnetwork comprise the H^{j} highest ranked embedding dimensions.

18. The system of claim 12, further comprising fine-tuning parameters of the pretrained LLM, wherein the training the router and the fine-tuning the parameters of the pretrained LLM are performed via an end-to-end training process.

19. The system of claim 12, wherein training the router to select, based on the target compression objective, the subnetwork comprises:
parameterizing the subnetwork as a set of network architecture parameters for each of the plurality of network architecture axes,
modeling at least one network architecture parameter of the set of network architecture parameters as:
a continuous approximation of a categorical distribution using Gumbel Softmax, or
a Bernoulli variable.

20. The system of claim 19, wherein the set of network architecture parameters comprises the parameters
$${D}^{j} , {N}_{A}^{j} , {H}^{j} , and {λ}_{i}^{j} ,$$
wherein where D^{j} is a number of hidden layer neurons of MLP sub-blocks,
$${N}_{A}^{j}$$
is a number of attention heads of MHA sub-blocks, H^{j} is a number of embedding dimensions of an embedding space, and
$${λ}_{i}^{j}$$
is a set of binary scalers, for i=1, . . . , N, where N is a number of transformer blocks in the pretrained LLM, and
wherein
$${D}^{j} , {N}_{A}^{j} ,$$
and H^{j} are modeled as continuous distributions using Gumbel Softmax and each
$${λ}_{i}^{j}$$
is modeled as a Bernoulli variable.

21. The system of claim 12, wherein the training the router to select, based on the target compression objective, the subnetwork is performed for a set of specified target parameter budgets.

22. The system of claim 12, wherein the plurality of transformer blocks of the subnetwork comprise at least one modulation head configured to generate, based on the selected subnetwork, a scale vector and/or a shift vector.

23. A machine-readable medium having stored thereon a set of instructions, which if performed by one or more processors, cause the one or more processors to:
obtain a pretrained LLM;
rank network architecture components of the pretrained LLM for a plurality of network architecture axes; and
train a router to select, based on a target compression objective, a subnetwork comprising a candidate set of network architecture components for one or more of the plurality of network architecture axes,
wherein the subnetwork comprises a plurality of transformer blocks having a uniform architecture.

24. The machine-readable medium of claim 23, wherein the network architecture axes comprise a multi-head attention (MHA) axis, a multi-layer perceptron (MLP) axis, an embedding axis, and an LLM depth axis,
wherein the network architecture components of the MHA axis are attention heads of MHA sub-blocks, wherein the network architecture components of the MLP axis are hidden layer neurons of MLP sub-blocks, wherein the network architecture components of the embedding axis are embedding dimensions of an embedding space, and wherein the network architecture components of the LLM depth axis are transformer blocks.

25. The machine-readable medium of claim 24, wherein the uniform architecture comprises a uniform number of attention heads of MHA sub-blocks, a uniform number of hidden layer neurons of MLP sub-blocks, and a uniform number of embedding dimensions of an embedding space.
